(19) United States
(12) Patent Application Publication
(10) Pub. No.: US 2014/0172387 A1
(43) Pub. Date: Jun. 19, 2014

(54) PREDICTION OF MOLECULAR BIOACTIVATION

(71) Applicant: Genentech, Inc., South San Francisco, CA (US)

(72) Inventor: Kevin A. FORD, San Francisco, CA (US)

(73) Assignee: Genentech, Inc., South San Francisco, CA (US)

(21) Appl. No.: 14/108,635

(22) Filed: Dec. 17, 2013

Related U.S. Application Data
(60) Provisional application No. 61/738,751, filed on Dec. 18, 2012.

(51) Int. Cl. G06F 19/00

(52) U.S. Cl. CPC G06F 19/704
USPC 703/2

(57) ABSTRACT

The present invention relates to methods for predicting molecular bioactivation, reactivity, and toxicity of compounds and their metabolites.

### RELATED APPLICATIONS

This application claims the benefit of U.S. Provisional Application No. 61/738,751, filed 18 Dec. 2012, the contents of which are incorporated herein by reference in their entirety.

### FIELD OF THE INVENTION

The present invention relates to methods for predicting molecular bioactivation, reactivity, and toxicity of compounds and their metabolites.

### BACKGROUND OF THE INVENTION

In silico methods for elucidation of metabolic pathways, bioactivation, and prediction of mutagenic potential of parent molecules (e.g., parent compounds) and their metabolites have become popular in recent years. The advantage of using in silico procedures is that they are quick, inexpensive, significantly reduce the use of animals for experimentation, and avoid the need for synthesis of compounds for testing. Various studies have shown that in silico approaches are reliable for predicting several important toxicological endpoints, including carcinogenicity^{1,2}, human Ether-à-go-go-Related Gene (hERG) alerts,^{3,4} and phospholipidosis.^{5,6} The importance of in silico methods is demonstrated in the fact that several regulatory agencies, including the U.S. Food and Drug Administration (FDA)⁷ and the European Medicines Agency (EMA),⁸ consider a candidate genotoxic impurity that is predicted to be negative for mutagenicity when screened through validated (Quantitative) Structure Activity Relationship ((Q)SAR) methods as being equivalent to being negative in the Ames assay. In light of this, many pharmaceutical research organizations are performing physicochemical property screens much earlier in drug discovery to try to anticipate toxicological endpoints.⁹⁻¹¹

Predictive metabolism platforms are becoming increasingly more popular due to the availability of software from established vendors, such as Meteor (Lhasa Ltd; Leeds, U.K.)¹² and Metasite (Molecular Discovery; Perugia, Italy).¹³ Biotransformations can greatly impact compound bioavailability, efficacy, chronic toxicity, and excretion rate and route. Both the parent compound and its metabolites may also interfere with endogenous metabolism or with the metabolism of other co-administered compounds. For example, the inhibition of certain metabolizing enzymes, such as cytochrome P450s and flavin-containing monooxygenases, can be associated with drug-drug interactions, which can have potentially fatal consequences for patients. In light of these issues, a detailed knowledge of metabolism is a crucial component during the early stages of drug discovery.¹⁴

One limitation with commercially available drug metabolism prediction software, however, is that a prediction of certain physicochemical properties of the associated metabolites (which are frequently the principle determinants of chemical bioactivation and toxicity),¹⁵ such as water solubility, stability, or reactivity, is typically not provided. Lack of such data leaves drug development teams with few options but to experimentally determine these properties, which may significantly delay drug development timelines and increase resource requirements. Therefore, a need exists for metabolism prediction methods that consider and address certain physicochemical properties of the parent compound's metabolites.

The present invention meets this need, in part by providing in silico methods to predict various in vivo behaviors of metabolites. In particular, the present invention shows that by examining in unison four physicochemical parameters, certain in vivo behaviors (e.g., bioactivation, toxicity) of drug or compound metabolites can be predicted. The four parameters include: electrostatic potential, a measure of potential energy per unit charge, e.g., a measure of sites of metabolic attack; heat of formation, a measure of molecular stability; energy or heat of solvation, a measure of water solubility; and E_{LUMO}-E_{HOMO} (energy of the lowest unoccupied molecular orbital-energy of the highest occupied molecular orbital; also known as the band gap), a measure of molecular reactivity. While these parameters have been used by physical chemists to gain insight into the behaviors of molecules in solution, their application in the fields of drug metabolism and pharmacokinetics (DMPK), investigative toxicology, and pharmacology is limited. The present invention demonstrates that these four physicochemical parameters serve as reliable indicators of reactivity, stability, and solubility of compounds and their metabolites, and therefore, useful for predicting molecular bioactivation and toxicity of compounds and their metabolites.

### SUMMARY OF THE INVENTION

The present invention provides, inter alia, methods for predicting various in vivo behaviors, molecular bioactivation, and toxicity of compounds and their metabolites.

In some aspects, the present invention provides a computer implemented method for predicting bioactivation of a compound and of a metabolite of the compound, the method comprising receiving the chemical structure of the compound and of the metabolite of the compound, calculating values for heat of formation, heat of solvation, electrostatic potential, and band gap of the compound and of the metabolite of the compound based on one or more stored algorithms, and outputting the values for heat of formation, heat of solvation, electrostatic potential, and band gap of the compound and the metabolite. In some embodiments, the method further comprises testing the bioactivation of the parent compound and of the metabolite of the parent compound. In certain embodiments, testing the bioactivation of the parent compound and of the metabolite of the parent compound is performed in vivo.

In other aspects, the present invention provides a computer implemented method for predicting toxicity of a compound and of a metabolite of the compound, the method comprising receiving the chemical structure of the compound and of the metabolite of the compound, calculating values for heat of formation, heat of solvation, electrostatic potential, and band gap of the compound and of the metabolite of the compound based on one or more stored algorithms, and outputting the values for heat of formation, heat of solvation, electrostatic potential, and band gap of the compound and the metabolite. In some embodiments, the method further comprises testing the toxicity of the parent compound and of the metabolite of the parent compound. In certain embodiments, testing the toxicity of the parent compound and of the metabolite of the parent compound is performed in vivo.

In other aspects, the present provides a computer implemented method for predicting bioactivation of a compound and of a metabolite of the compound, the method comprising receiving the chemical structure of the compound and of the metabolite of the compound, calculating values for one or more physicochemical parameters selected from the group consisting of heat of formation, heat of solvation, electrostatic potential, and band gap of the compound and of the metabolite of the compound based on one or more stored algorithms, and outputting the values for heat of formation, heat of solvation, electrostatic potential, and band gap of the compound and the metabolite. In some embodiments, the method further comprises testing the bioactivation of the parent compound and of the metabolite of the parent compound. In certain embodiments, testing the bioactivation of the parent compound and of the metabolite of the parent compound is performed in vivo.

In another aspect, the present invention provides a computer implemented method for predicting toxicity of a compound and of a metabolite of the compound, the method comprising receiving the chemical structure of the compound and of the metabolite of the compound, calculating values for one or more physicochemical parameters selected from the group consisting of heat of formation, heat of solvation, electrostatic potential, and band gap of the compound and of the metabolite of the compound based on one or more stored algorithms, and outputting the values for heat of formation, heat of solvation, electrostatic potential, and band gap of the compound and the metabolite. In some embodiments, the method further comprises testing the toxicity of the parent compound and of the metabolite of the parent compound. In certain embodiments, testing the toxicity of the parent compound and of the metabolite of the parent compound is performed in vivo.

In an additional aspect, the present invention provides a data processing system for use in predicting molecular bioactivation of a compound and of a metabolite of the compound, the system comprising a processor and accessible memory, the system particularly configured to perform the acts of receiving the chemical structure of the compound and of the metabolite of the compound, calculating values for heat of formation, heat of solvation, electrostatic potential, and band gap of the compound and of the metabolite of the compound based on one or more stored algorithms, and outputting the values for heat of formation, heat of solvation, electrostatic potential, and band gap of the compound and the metabolite.

In yet another aspect, the present invention provides a data processing system for use in predicting toxicity of a compound and of a metabolite of the compound, the system comprising a processor and accessible memory, the system particularly configured to perform the acts of receiving the chemical structure of the compound and of the metabolite of the compound, calculating values for heat of formation, heat of solvation, electrostatic potential, and band gap of the compound and of the metabolite of the compound based on one or more stored algorithms, and outputting the values for heat of formation, heat of solvation, electrostatic potential, and band gap of the compound and the metabolite.

The present invention further provides a non-transitory computer readable storage medium comprising computer readable instructions for calculating values for heat of formation, heat of solvation, electrostatic potential, and band gap of a compound and of a metabolite of the compound, and outputting the values to a user, a user interface device, a monitor, a printer, a computer readable storage medium, or a local or remote computer system.

In certain embodiments of the present methods, outputting the values for heat of formation, heat of solvation, electrostatic potential, and band gap of a compound and of a metabolite of the compound is to a user, a user interface device, a monitor, a printer, a data storage medium, a computer readable storage medium, or a local or remote computer system. In other embodiments, outputting the values includes storing the values in a database or a library. In yet other embodiments, outputting the values includes displaying the values of heat of formation, heat of solvation, electrostatic potential, and band gap of the compound and of the metabolite of the compound.

### BRIEF DESCRIPTION OF THE DRAWINGS

U.S. Provisional Patent Application No. 61/738,751, filed 18 Dec. 2012, to which the instant patent application claims priority, contains at least one drawing executed in color. Copies of U.S. Provisional Patent Application No. 61/738,751 with color drawing(s) will be provided by the U.S. Patent and Trademark Office upon request and payment of the necessary fee.

FIGS. 1A, 1B, 1C, 1D, 1E, and 1F set forth structures of aniline and phenylamine-containing drugs (FIG. 1A), acetaminophen (FIG. 1B), vinyl chloride (FIG. 1C), Nefazodone (FIG. 1D), imidacloprid (FIG. 1E), and cytosine (FIG. 1F).

FIGS. 2A and 2B set forth metabolic pathways for acetaminophen, vinyl chloride (adapted from Whysner, J. et at, 1996),¹³⁷ Nefazodone (adapted from Peterman, S. et at, 2006)¹³⁸ and imidacloprid (adapted from Ford, K. A. and Casida, J. E., 2007)¹²³. The identities of the metabolites are described in Table 1.

FIGS. 3A, 3B, 3C, 3D, 3E, and 3F set forth electrostatic potential maps of aniline (non-planar (i) and planar (ii) conformations) (FIG. 3A), (i) acetaminophen and (ii) NAPQI (FIG. 3B), (i) vinyl chloride and (ii) chloroacetaldehyde (FIG. 3C), (i) Nefazodone and (ii) Nefazodone-quinoneimine (FIG. 3D), (i) imidacloprid and (ii) imidacloprid-NH (FIG. 3E), and cytosine (FIG. 3F) (ESP contours are coded in grey-scale (negative to positive) and potentials are provided in kJ/mol.)

FIGS. 4A-4L set forth structures and electrostatic potential maps of several conformers of DNA. FIGS. 4A, 4B, 4C, and 4D: 16 base-pair B-DNA duplex shown in longitudinal and side-view (PDB: 3BSE); FIGS. 4E, 4F, 4G, and 4H: Left-Handed Z-DNA Double Helix in longitudinal and side-view (PDB: 2DCG); FIGS. 4I and 4J: A-DNA decamer (PDB: 213D); FIGS. 4K and 4L: A-DNA tetramer (PDB: 1ANA).

FIG. 5 depicts computing system 1100 with a number of components that may be used to perform the processes and methods described herein. The main system 1102 includes a motherboard 1104 having an input/output (“I/O”) section 1106, one or more central processing units (“CPU”) 1108, and a memory section 1110, which may have a flash memory card 1112 related to it. The I/O section 1106 is connected to a display 1124, a keyboard 1114, a disk storage unit 1116, and a media drive unit 1118. The media drive unit 1118 can read/write a computer-readable medium 1120, which can contain programs 1122 and/or data.

FIG. 6 depicts a block diagram showing a process for predicting molecular bioactivation in accordance with one embodiment of the present invention.

### DETAILED DESCRIPTION OF EMBODIMENTS OF THE INVENTION

The present invention provides, inter alia, in silico methods for predicting various in vivo behaviors and molecular bioactivation of compounds and their metabolites.

The present invention demonstrates that electrostatic potential (ESP) and three additional molecular physicochemical parameters (heat of formation, heat of solvation, and E_{LUMO}-E_{HOMO}) can serve as complementary indicators of the behavior of metabolites in vivo. Five diverse compounds (acetaminophen, aniline/phenylamines, imidacloprid, Nefazodone, and vinyl chloride) are provided as examples to illustrate the utility of this multi-dimensional approach in predicting molecular bioactivation. In each case the prediction of molecular bioactivation of compounds and their metabolites using the methods provided herein was in agreement with experimental data described in the scientific literature.

A further example of the usefulness of ESP is provided by an examination of the use of this physicochemical parameter in providing an explanation for the sites of attack of the nucleic acid cytosine. Exploration of sites of attack of nucleic acids is important as adducts of DNA are frequently mutagenic.

Definitions

The terms “bioactivation” or “bioactivated” refers to a metabolic process in which a metabolite (or metabolites) of a parent compound is rendered more toxic, energetic, or pharmacologically active compared to that of the parent compound. Bioactivation encompasses the effects of metabolism on various molecular properties, which include compound stability (as determined by heat of formation), compound solubility (as determined by heat of solvation), compound reactivity (as determined by difference between the energy of the lowest unoccupied molecular orbital and the energy of the highest occupied molecular orbital, also known as the band gap), and electrostatic potential (as a measure of sites of metabolic attack); each of which may increase, decrease, or remain unchanged during metabolic processes.

The terms “parent molecule” and “parent compound” refer to a starting compound or, in this instance, a candidate or investigational drug or compound.

The terms “metabolite” and “metabolites” refer to the molecules or compounds formed from a metabolic process (e.g., metabolism), including the molecules or compounds associated with compound degradation and elimination.

Electrostatic Potential. Electrostatic potential (ESP) is a useful physicochemical property of a molecule that provides insights into inter- and intra-molecular associations, as well as prediction of likely sites of electrophilic and nucleophilic metabolic attack. Any alteration in the electrical charge of a molecule (e.g., due to variation in the pH of the solution in which a molecule resides, or a change in electric field)^{16, 17} changes the electrostatic energy (or potential) in the surrounding space to create a more positively or negatively charged local environment.¹⁸ Electrostatic potential (ESP) is an important property that plays a crucial role in the interaction of molecules; it can be defined simply as the difference in electrical charge between any two points. The most fundamental equation of electrostatics is the Poisson equation¹⁹ (Equation 1):

∇²Φ(r)=−4πρ(r) Equation 1

which relates spatial variation of the potential, Φ, with position r to the charge density distribution ρ, where the permittivity of free space is unity. When the charge distribution is described in terms of a set of point charges (q), the Poisson equation becomes Coulomb's law, which calculates the force of attraction between point charges of molecules (e.g. such as a drug inhibitor and an amino acid at the active site of a target enzyme). Coulomb's law²⁰ states that the magnitude of the electrostatic force between two point charges (q₁ and q₂) is directly proportional to the product of the magnitudes of charges and inversely proportional to the square of the distances between them (r²), Equation 2:

$$F ∝ \frac{q 1 q 2}{{r}^{2}} \qquad Equation 2$$

The inverse-square nature of this law signifies that the closer the proximity of the charges the greater the electrostatic force of attraction between the two charges. This is an important consideration in the design of novel drug inhibitors, during which every effort must be made to maximize interactions at the active site of the enzyme by ensuring that the candidate inhibitor does not possess highly repulsive charged properties which would likely produce a non-potent compound.

The direction of the force between charges is dictated by the principles of electrostatics, i.e. that like charges repel one another (e.g. two positive charges), whereas unlike charges (i.e. a positive and a negative charge) will attract one another. The significance of these electrostatic principles to drug research is that unlike charges lead to negative, more stabilizing interactions and consequently an increased probability for the formation of a more stable inhibitor-target complex, whereas the interaction energy between like charges is positive and is destabilizing.²¹ Rewriting the Poisson equation in terms of Coulomb's law gives the following (Equation 3):

$$Φ ( r ) = \sum \frac{{q}_{i}}{( r - {r}_{i )}} \qquad Equation 3$$

where rᵢ is the position, and qᵢ the magnitude of the ith point charge. Essentially all electrostatic models used in studying macromolecules, such as DNA, are based on the Poisson equation. If a region of a molecule responds in a uniformly distributed way to an electric field, then the relationship between polarization density (χ), and induced dipole moment over the volume of the region (P), is given by Equation 4:

P=χE Equation 4

where E is the average electric field in that region. Since the region responds in a uniform manner, a permittivity constant, ε, can be applied to the Poisson and Coulomb equations. However if the dielectric varies through space, then Coulomb's law becomes invalid, while the Poisson equation becomes Equation 5:

∇·ε(r)∇Φ(r)=−4πρ(r) Equation 5

where Φ is now a function of the position r.

ESP is well established as an effective tool for interpreting and predicting molecular reactive behavior.²²⁻²⁴ Two important applications of ESP are the prediction of regions of a molecule that are susceptible to electrophilic or nucleophilic metabolic attack (which serves as a valuable tool in drug metabolism research) and prediction of mutagenicity (which is important in investigational toxicology assessments). Electrophiles²⁵ (electron-deficient, positively charged species) tend to be attracted to regions of a molecule in which the ESP attains its most negative values (the local minima, Vₘᵢₙ) since these are where the effects of the molecule's electrons are most dominant. Nucleophiles²⁵ (electron-rich, negatively charged species) are especially attracted to areas where the ESP is the most positive (the local maxima, Vₘₐₓ). The ESP due to a set of nuclei {Z_{A}} and the electronic density ρ(r) of the molecule is described in Equation 6²⁶

$$E S P = \sum \frac{{Z}_{A}}{\vert {R}_{A} - r \vert} - \int \frac{ρ ( {r}^{′} ) d {r}^{′}}{\vert {r}^{′} - r \vert} \qquad Equation 6$$

where Z_{A} is the charge on nucleus A, located at R_{A}.²⁷⁻²⁹ The first term on the right of Equation 6 represents the contribution of the nuclei (which is positive); the second term on the right of Equation 6 describes the contribution of the electrons (which is negative). The electronic density is obtained from ab initio (or semi-empirical) calculations and, accordingly, are approximate, and consequently the measure of the ESP of a molecule is also an approximation. Previous studies have shown that Hartree-Fock wave functions give good results for properties that are calculated from ρ(r), such as ESP.³⁰⁻³² Furthermore, investigations have shown that a reliable measure of ESP can be obtained even with self-consistent-field (SCF) wave functions that are not near Hartree-Fock quality.³³⁻³⁵ ESP may also be determined experimentally by diffraction methods³⁶⁻³⁸ but at present derivations based on quantum methods remain the more accurate approach.

ESP plays an important role in maintaining both the structural properties of nucleic acids and proteins, including enzymes and transporters.³⁹⁻⁴⁴ For example, interactions such as salt bridges, Van der Waal interactions, and hydrogen bonds, which are all primarily electrostatic in nature,⁴⁵⁻⁴⁷ are critical in maintaining and stabilizing the structure of proteins.⁴⁸⁻⁵⁰ Therefore, it is essential to understand the role played by electrostatic forces of biomolecules and their ligands in order to improve the structure activity relationships (SAR) efforts in the design of more efficacious pharmaceuticals.

As demonstrated herein, ESP maps provided a quick and convenient method to visualize metabolic ‘hot-spots’ as well as elucidate mutagenic potential of molecules. Since the early work of Politzer and colleagues,^{22, 24, 50-52} ESP has been routinely used as a tool for assisting medicinal chemists in the synthesis of potent drug candidates for numerous indications including cancer,⁵³⁻⁵⁵ HIV,⁵⁶⁻⁵⁸ depression,^{59, 60} malaria,^{61, 62} bacterial infections^{63, 64} and epileptic seizures^{65, 66} to name a few. However, the use of ESP to aid in decision making in the fields of DMPK, investigative toxicology, and pharmacology has been limited.

Heat of formation. Heat of formation (ΔH_{f}^{⊖}) is the change of enthalpy that accompanies the formation of 1 mole of a pure substance from its elements, with all substances in their standard states (i.e. T=298 K and P=1 atm). ΔH_{f}^{⊖} can be calculated from Hess's law (also known as the law of constant heat summation), which proves that the heat change (ΔH) for a single reaction can be calculated from the difference between the ΔH_{f}^{⊖} of the products and the ΔH_{f}^{⊖} of the reactants⁶⁷ (Equation 7):

ΔH_{f}^{⊖}_{reaction}=ΣΔH_{f}^{⊖}_{products}−ΣΔH_{f}^{⊖}_{reactants} Equation 7

ΔH_{f}^{⊖} plays an important role in the thermodynamic stability of compounds because the more negative the ΔH_{f}^{⊖}, the more stable the compound.⁶⁸ Stability is an important consideration in the prediction of metabolic pathways as it stands to reason that the more stable a metabolite the less likely it is to be labile and consequently it will likely reside for a longer time in the body.

Energy of solvation. Solvation is the process of attraction of molecules of a solvent (e.g. water) with molecules of a solute. The energy of solvation is the Gibbs free energy required for solvation to occur and energy of solvation is required in order to firstly break bonds within the solute and within the solvent and then to form new bonds between the solvent and solute. Knowledge of the energy of solvation of a compound is important as part of distribution, metabolism, and excretion studies because it influences whether or not a compound is likely to be distributed in water or stored in lipid; if a metabolite is likely to require Phase II conjugation in order to be excreted; and whether a compound (e.g., a metabolite) is more or less water soluble than the parent molecule and therefore whether it is likely to be excreted in urine or bile.

E_{LUMO}-E_{HOMO}. The lowest unoccupied molecular orbital (LUMO) and the highest occupied molecular orbital (HOMO) are the so-called frontier orbitals, and they play a critical role in chemical reactivity.⁶⁹ The difference in energies between the energy of the LUMO (E_{LUMO}) and the energy of the HOMO (E_{HOMO}) is called the band gap (i.e. E_{LUMO}-E_{HOMO}). The smaller the band gap of a molecule the more likely it is to be a reactive compound. For example, a decrease in the band gap from a parent molecule to a metabolite indicates that the metabolite is more energetic than the parent molecule, and thus is likely to undergo bioactivation. Likewise, an increase in the band gap from a parent molecule to a metabolite indicates that the metabolite is less energetic than the parent molecule, and thus is less likely to undergo bioactivation.

The present invention demonstrates that by determining the values for these four physicochemical parameters of a compound and its metabolites, certain in vivo behaviors of the metabolites can be predicted, including predicting molecular bioactivation and toxicity. As stated above, the four physicochemical parameters include: electrostatic potential, a measure of potential energy per unit charge, e.g., a measure of sites of metabolic attack; heat of formation, a measure of molecular stability; energy or heat of solvation, a measure of water solubility; and E_{LUMO}-E_{HOMO} (energy of the lowest unoccupied molecular orbital minus energy of the highest occupied molecular orbital—also known as the band gap), a measure of molecular reactivity.

In some aspects, the present invention provides methods for predicting molecular bioactivation of a compound and of a metabolite of a compound. In some embodiments, the present invention provides a computer implemented method for predicting bioactivation of a compound and of a metabolite of the compound, the method comprising receiving the chemical structure of the compound and the chemical structure of the metabolite of the compound, calculating a value for heat of formation (a measure of stability), heat of solvation (a measure of solubility), electrostatic potential (which can identify metabolic hot-spots in the compound and the metabolite), and band gap (a measure of reactivity), and outputting the values (e.g., producing an output) for heat of formation, heat of solvation, electrostatic potential, and band gap of the compound and of the metabolite. In other embodiments, the methods comprise storing the values in a database. In other embodiments, the methods comprise displaying the values.

In some embodiments, the metabolites (and the chemical structures thereof) of the parent compound are known. In other embodiments, the metabolites (and the chemical structures thereof) of the parent compound are determined experimentally using standard methods in the art. In other embodiments, the metabolites (and the chemical structures thereof) of the parent compound are predicted by, e.g., commercially available software (e.g., Meteor, Metasite).

ESP maps provide a way to identify sites or areas of potential metabolic attack within a compound or metabolite. Based on ESP analysis, a metabolite displaying an area having increased positive ESP or displaying an area having decreased positive ESP (compared to the parent compound) indicates that this area is more or less prone to nucleophilic attack (compared to the parent compound), respectively. Conversely, a metabolite displaying an area having increased negative ESP or displaying an area having decreased negative ESP (compared to the parent compound) indicates that this area is more or less prone to electrophilic attack (compared to the parent compound), respectively. A metabolite that is more prone to electrophilic or nucleophilic attack (compared to that of its parent compound) suggests that the metabolite is more likely (i.e., has more potential) to be bioactivated and thus predictive of the metabolite displaying toxicity. Accordingly, a metabolite displaying an area having increased positive ESP value (compared to its parent compound) suggests that the metabolite is likely to display toxicity.

A greater value for heat of formation of a metabolite compared to that of the parent compound indicates that the metabolite is less stable, and thus has more potential for bioactiviation and toxicity (relative to the parent compound). A greater value for heat (or energy) of solvation of a metabolite compared to that of the parent compound indicates that the metabolite is less water soluble, and thus has more potential for bioactivation and toxicity (relative to the parent compound). A lesser value for band gap of a metabolite compared to that of the parent compound indicates that the metabolite is more energetic, and thus has more potential for bioactivation and toxicity (relative to the parent compound).

Heat of formation is a measure of molecular stability. A more negative value for heat of formation of a metabolite compared to that of the parent compound indicates that the metabolite is more stable (e.g., less reactive) compared to the parent compound. A more stable metabolite (compared to that of its parent compound) suggests (and thus predictive) that the metabolite is less likely to be bioactivated and to display toxicity. Accordingly, a more negative value for heat of formation of a metabolite compared to that of its parent compound suggests (and thus predictive) that the metabolite is less likely to be bioactivated and to display toxicity. Alternatively, a greater value for heat of formation of a metabolite compared to that of the parent compound indicates that the metabolite is less stable (e.g., more reactive) compared to the parent compound. A less stable metabolite (compared to that of its parent compound) suggests (and thus predictive) that the metabolite is more likely to be bioactivated and to display toxicity. Accordingly, a greater value for heat of formation of a metabolite compared to that of its parent compound suggests (and thus predictive) that the metabolite is more likely to be bioactivated and to display toxicity.

Energy or heat of solvation is a measure of water solubility. A lower value for energy of solvation of a metabolite compared to that of the parent compound indicates that the metabolite is more water-soluble compared to the parent compound. A metabolite that is more water-soluble (compared to that of its parent compound) suggests (and thus predictive) that the metabolite is more likely to be excreted in urine and thus less likely to be bioactivated and to display toxicity. Accordingly, a more negative value for energy of solvation of a metabolite compared to that of its parent compound suggests (and thus predictive) that the metabolite is less likely to be bioactivated and to display toxicity. Alternatively, a greater value for heat of solvation of a metabolite compared to that of the parent compound indicates that the metabolite is less water-soluble compared to the parent compound. A metabolite that is less water-soluble (compared to that of its parent compound) suggests (and thus predictive) that the metabolite is less likely to be excreted in the urine and thus more likely to be bioactivated and to display toxicity. Accordingly, a greater value for heat of solvation of a metabolite compared to that of its parent compound suggests (and thus predictive) that the metabolite is more likely to be bioactivated and to display toxicity.

E_{LUMO}-E_{HOMO} (or band gap) is a measure of chemical reactivity. A lower band gap value of a metabolite compared to that of its parent compound indicates that the metabolite is more reactive than the parent compound. A metabolite that is more reactive (compared to that of its parent compound) suggests (and thus predictive) that the metabolite is more likely to be bioactivated and to display toxicity. Accordingly, a lower band gap value of a metabolite compared to that of its parent compound suggests (and thus predictive) that the metabolite is more likely to be bioactivated and to display toxicity. Alternatively, a greater band gap value of a metabolite compared to that of its parent compound indicates that the metabolite is less reactive that the parent compound. A less reactive metabolite that is less reactive (compared to that of its parent compound) suggests (and thus predictive) that the metabolite is less likely to be bioactivated and to display toxicity. Accordingly, a greater band gap value of a metabolite compared to that of its parent compound suggests (and thus predictive) that the metabolite is less likely to be bioactivated and to display toxicity.

Based on the values obtained for each of the physicochemical parameters described above for a compound and its metabolite, a weight of evidence analysis can be performed to evaluate whether a metabolite is more or less stable (by comparing values of heat of formation of the metabolite), more or less soluble (by comparing values of energy of solvation of the metabolite), more or less metabolically labile (by comparing ESP maps of the metabolite), or more or less reactive (e.g., more or less energetic) (by comparing values of band gap of the metabolite) compared to that of the parent compound.

Weight of evidence can be applied to each of the calculated values for heat of formation, heat of solvation, and band gap (here, assigning each of the energies equal weight) by, e.g., comparing each value calculated for a metabolite to each value calculated for the parent compound as follows: 0 (metabolite unlikely to be bioactivated and/or to have toxicity relative to the parent compound); 1 (metabolite has low potential for bioactivation and/or to have toxicity relative to the parent compound); 2 (metabolite has a moderate potential for bioactivation and/or to have toxicity relative to the parent compound); and 3 (metabolite has high potential for bioactivation and/or to have toxicity relative to the parent compound. For example, a greater value for heat of formation of the metabolite compared to that of the parent compound is assigned a plus 1; a greater value for heat of solvation of the metabolite compared to that of the parent compound is assigned a plus 1; and a lower value for band gap of the metabolite compared to that of the parent compound is assigned a plus 1. (See Examples 1, 2, 3, 4, and 5 and Tables 1, 2, 3, 4, and 5.)

In some aspects, the present methods provide means for predicting molecular bioactivation by determining if a metabolite is more or less energetic than its parent compound. In some embodiments, whether a metabolite is more or less energetic than its parent compound is determined by comparing the value of one or more physicochemical parameters of the parent compound to that of the metabolite, wherein the one or more physicochemical parameters is selected from the group consisting of heat of formation, heat of solvation, electrostatic potential, and band gap. Accordingly, in some embodiments, the present methods include comparing the value of one or more of these parameters of a parent compound to that of a metabolite of the parent compound, and determining whether or not the metabolite is more or less energetic (and thus more or less potential for bioactivation) than the parent compound.

In other aspects, the methods provided by the present invention are useful for selecting an appropriate animal species for in vivo toxicology testing of, for example, candidate or investigational drug compounds. Selection of an appropriate animal species for toxicology studies is an important and often times difficult problem faced by toxicologists. If an animal species is selected for toxicology studies that does not produce the most toxicologically-relevant metabolites in comparison to metabolites produced in humans, then the choice of animal species may be an inappropriate one. Ideally, the animal species selected for in vivo toxicology studies will be one which will most likely (or most assuredly) result in generation of metabolites which match or closely mimic the metabolites generated in humans. The selection of an appropriate animal species for in vivo toxicology studies helps to ensure a more thorough and relevant examination and evaluation of the potential toxicity of such metabolites in humans.

During drug development, metabolites of a candidate drug compound are often identified in vitro prior to in vivo toxicology studies. Methods for identifying or predicting metabolites of a compound are well known in the art. For example, in one method, a candidate drug (e.g., small chemical compound) is added to individual cell cultures containing cells (typically liver cells) of human, rat, dog, and monkey (e.g., cynomolgus) origin. The candidate drug is incubated with each of the cell cultures from the various animal species individually in order for metabolites of the compound to be generated by the cells of each animal species. The metabolites derived from each animal species are identified (e.g., by mass spectrometry), and the metabolite profile (i.e., the specific metabolites of the compound) obtained from each animal species are compared to that obtained from the metabolites obtained from human cells.

Once one or more metabolites of a parent compound are identified by, e.g., in vitro analysis, an appropriate animal species is then selected for in vivo toxicology studies. Ideally, the animal species selected for such in vivo toxicology studies will be one which most likely will result in generation of metabolites which match or closely mimic the metabolites generated in humans.

Unfortunately, due to differences in metabolizing enzymes associated with different animal species, species-specific metabolites are not uncommon. A non-human animal (e.g., non-human animal cells in culture, such as rat, dog, monkey, mouse cells) may produce one or more metabolites which differ from that produced in humans (e.g., human cells in culture). Uncertainty may then exist as to whether or not these non-human-specific metabolites are bioactive metabolites which may or may not display toxicity. Any display of toxicity of these non-human-specific metabolites in subsequent in vivo toxicology studies would not be relevant to human toxicity (as these metabolites would not be observed in humans), therefore complicating the analysis of the degree of toxicity of metabolites common to both the non-human animal and humans.

Having metabolite profiles from the different animal species in hand, drug development teams and toxicologists ultimately have to decide which animal species to use for in vivo toxicology studies, often without knowing whether or not any one or more of the non-human-specific metabolites may display toxicity. The present invention provides a means for guiding toxicologists in selection of appropriate animal species by providing methods for predicting the molecular bioactivation (and potential toxicity) of such metabolites. Use of the present methods will identify whether or not any one or more metabolites is of concern (e.g., may display toxicity), therefore reducing or eliminating the need for additional in vitro or in vivo testing.

Alternatively, one or more metabolites may be produced or observed in humans (e.g., by human cells in culture) which are not produced or observed in non-human animals (e.g., non-human animal cells in culture). Uncertainty may then exist as to whether or not any one or more of the human-specific metabolites are bioactive metabolites with potential toxicity. Without such metabolites produced or observed in non-human animals, in vivo toxicology studies in non-human animals will not provide information on toxicity that is relevant to toxicity that may be observed in humans. The present invention provides methods for predicting the molecular bioactivation of such metabolites, thereby guiding toxicologists in appropriate animal species selection, as the present methods will identify whether or not any one or more metabolites is of concern, thus reducing or eliminating the need for additional in vitro or in vivo testing.

The methods for predicting bioactivation or toxicity of a compound and of a metabolite, as described herein, can be computer implemented and, at least in part, can be thus performed in silico, using a computer. Any general purpose computer may be configured to a functional arrangement for the methods disclosed herein. The hardware architecture of such a computer can be realized by a person skilled in the art, and may comprise hardware components including one or more processors (CPU), a random-access memory (RAM), a read-only memory (ROM), an internal and/or external data storage medium (e.g., a hard disk drive). The computer preferably comprises one or more graphic boards for processing and outputting values to display means.

Examples of computing devices for use with the present methods include a desktop computer, a laptop computer, a tablet computer, network appliances, workstations, or other devices configured to process digital instructions. The system memory can include read only memory and/or random access memory.

The computing device may also include a secondary storage device, such as a hard disk drive, for storing digital data. The secondary storage device is connected to the system bus by a secondary storage interface. The secondary storage devices and their associated computer readable media provide nonvolatile storage of computer readable instructions (including application programs and program modules), data structures, and other data for the computing device. Computer readable storage media include magnetic cassettes, flash memory cards, digital video disks, compact disc read only memories, random access memories, or read only memories.

Input to the computing device can be performed through one or more input devices. Examples of input devices include a keyboard, mouse, microphone, and touch sensor (such as a touchpad or touch sensitive display), etc. The input devices are often connected to the processing device through an input/output interface that is coupled to the system bus. The input devices can be connected by any number of input/output interfaces, such as parallel port, serial port, game port, or a universal serial bus. Wireless communication between input devices and the interface is possible as well, including, for example, infrared, BLUETOOTH® wireless technology, 802.11a/b/g/n, cellular, or other radio frequency communication systems.

One object of the present invention may also be achieved by supplying a system or an apparatus with a storage medium which stores program code of software that realizes the functions of the described embodiments, and causing a computer of the system or apparatus to read out and execute the program code stored in the storage medium. In this case, the program code itself reads out from the storage medium realizes the functions of the embodiments described herein, so that the storage medium storing the program code also and the program code per se constitutes in part the present invention.

### EXAMPLES

The following are examples of methods of the invention. It is understood that various other embodiments may be practiced, given the general description provided above.

General Methods

The present invention examined five molecular properties (electrostatic potential, heat of formation, heat of solvation, and E_{LUMO}-E_{HOMO}) as complementary indicators of predicting the behavior of metabolites in vivo. Five diverse compounds are presented below as examples to illustrate the utility of this multi-dimensional approach in predicting bioactivation. These compounds include acetaminophen (an important analgesic), aniline/phenylamine (a functional group present in numerous medications), imidacloprid (an extensively-used insecticide), Nefazodone (an hepatotoxic antidepressant), and vinyl chloride (a known human carcinogen). In each case the predicted data based on the methods provided herein agreed with experimental data described in the scientific literature.

Geometries of the compounds utilized in the studies presented herein were fully optimized by using density functional theory (DFT) with Becke's three-parameter hybrid exchange function and the Lee-Yang-Parr correlation function (B3LYP) in combination with the 6-31+G(d) basis set using Gaussian '09 (Gaussian, Wallingford, Conn.).⁷⁰ Energies of the lowest unoccupied molecular orbital (E_{LUMO}) and highest occupied molecular orbitals (E_{HOMO}) were subsequently calculated using these settings. Standard heats of formation in the gas phase (ΔH_{f}^{⊖}) and solvation energies were calculated using the PM3 semi-empirical method in Spartan '10 (Wavefunction, Irvine, Calif.) and all values were verified with MOPAC 2012 (CAChe Research, Beaverton, Oreg.) using the same settings and level of theory.

Electrostatic potential maps of the 5 small compounds, and their selected metabolites as discussed herein, were constructed using Spartan '10. Spartan '10 calculates the electrostatic potential at selected points on the 0.002 isodensity surface and maps the surface by color, where different colors are used to identify different potentials. The electrostatic potential varies from most negative (red) to most positive (blue) as follows: red<orange<yellow<green<blue.⁷¹

Electrostatic potential maps of A-, B- and Z-DNA confirmations were constructed using GAMESS⁷² and Avogadro open-source software, vers. 1.0.3, using the MMFF94 force field and minimization of DNA, according to manufacturer's instructions.⁷³ The same color scale as Spartan '10 was used for the GAMESS and Avogadro analysis. Chemical structures were constructed using ChemBioDraw Ultra, vers. 12.0.2.1076 (CambridgeSoft, Cambridge, Mass.).

### Example 1

### Phenylamine

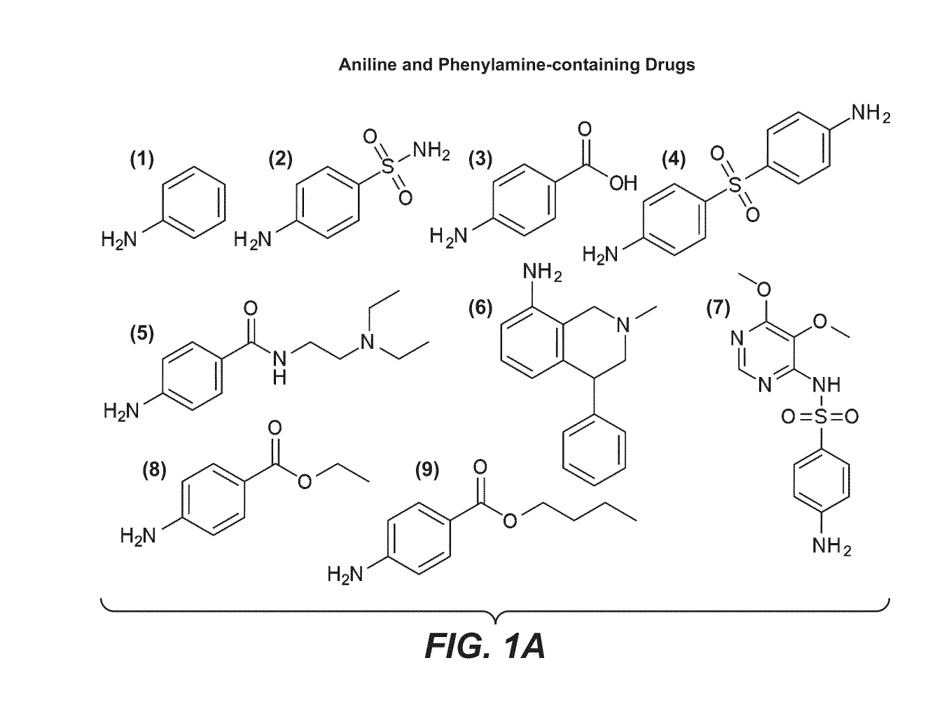

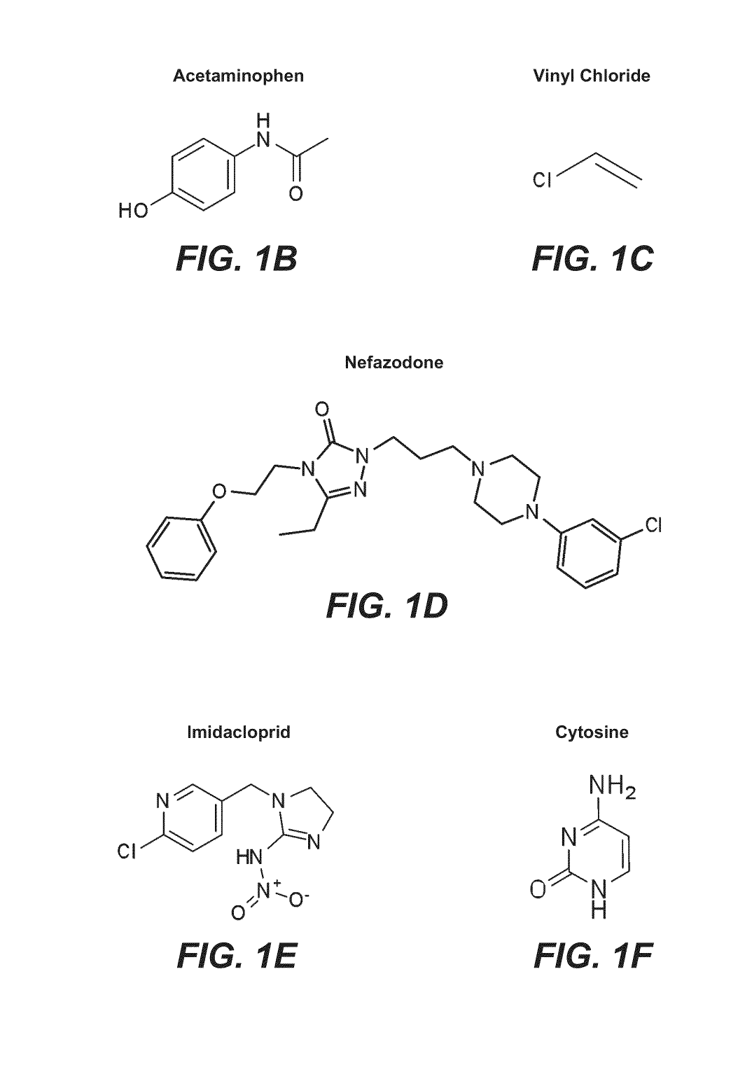

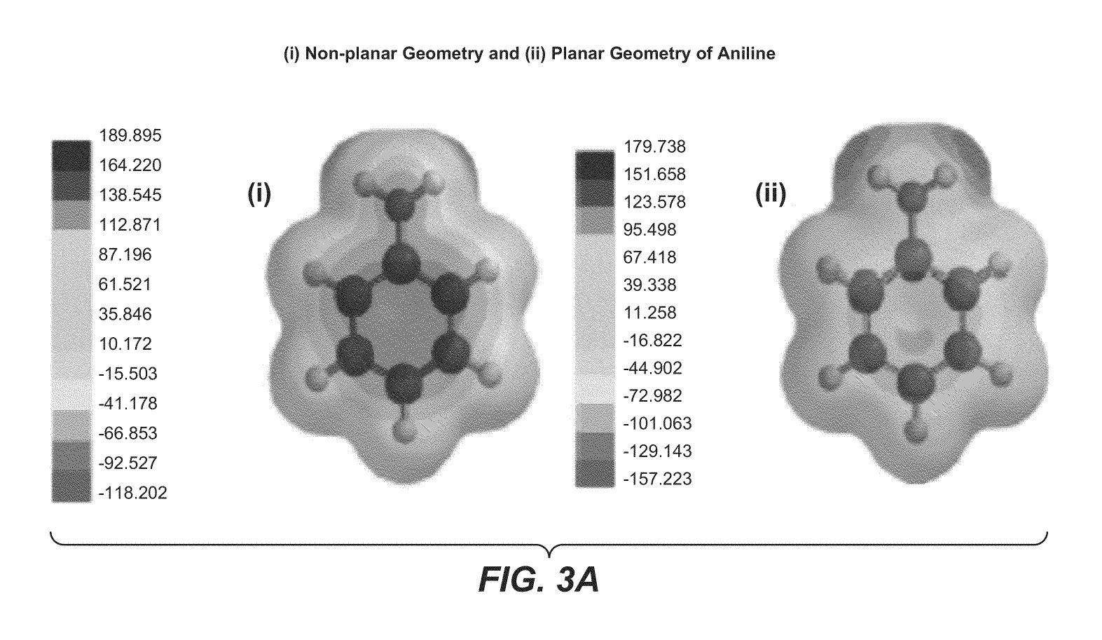

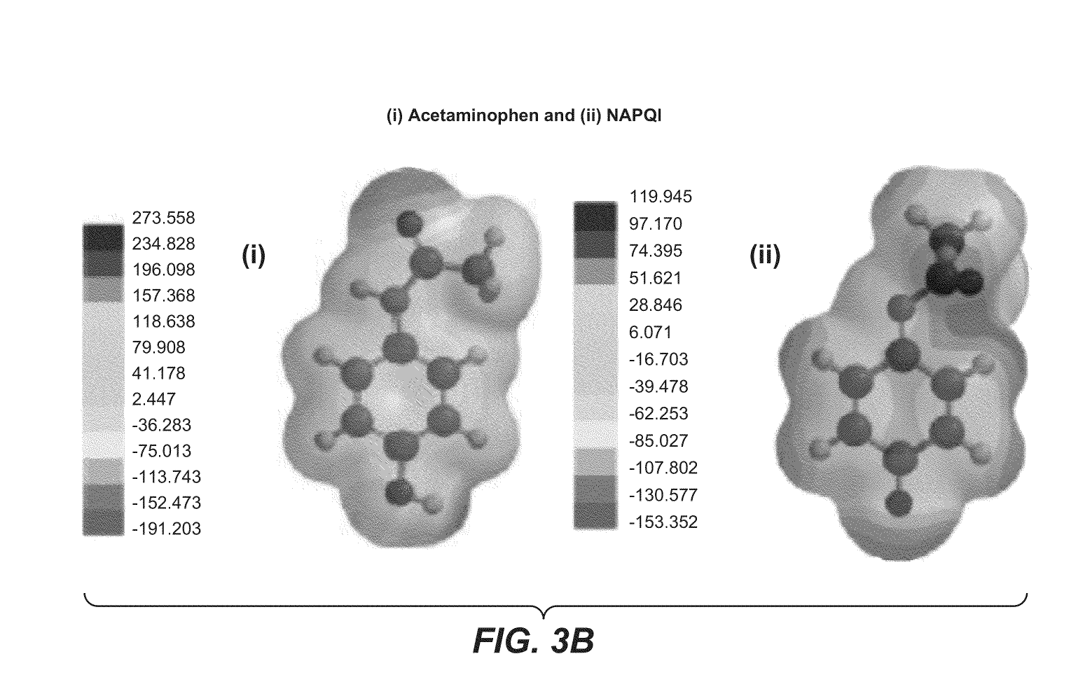

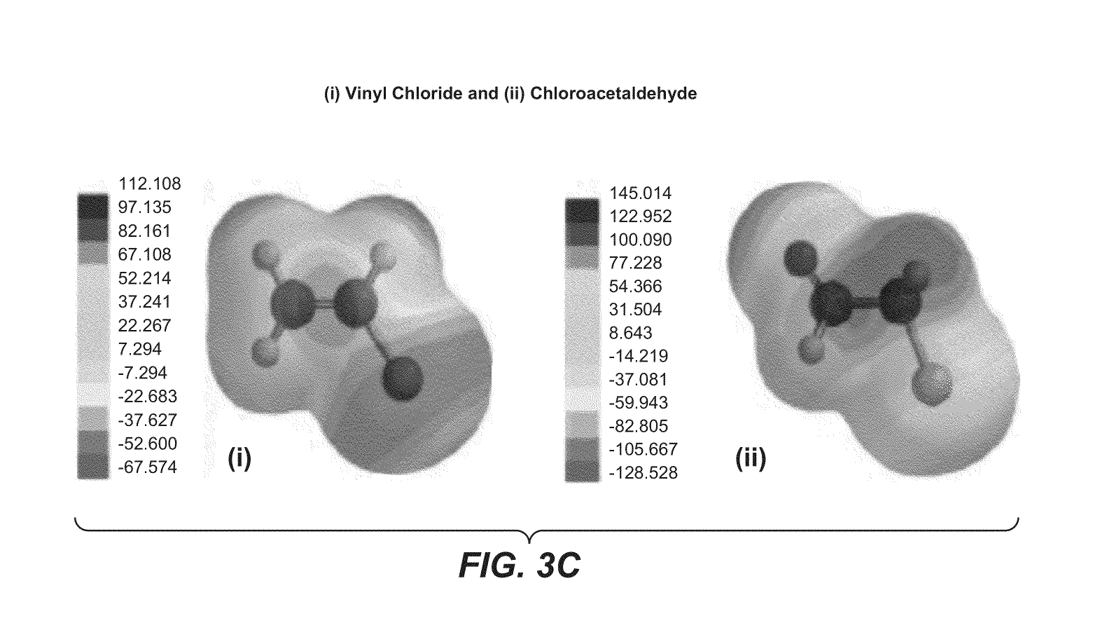

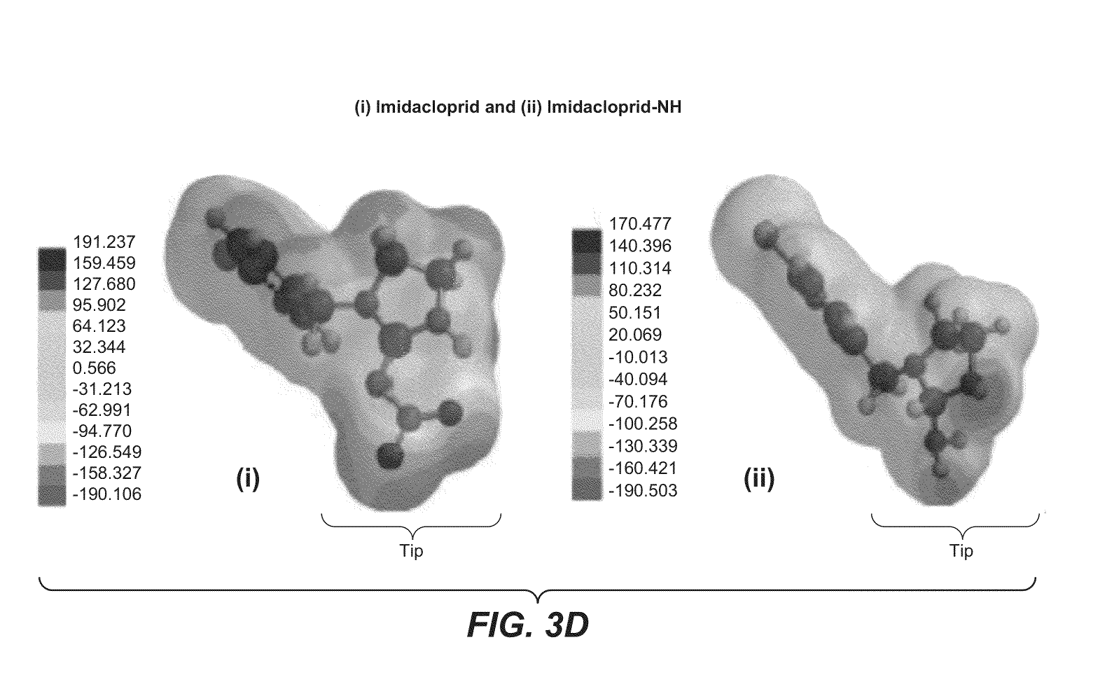

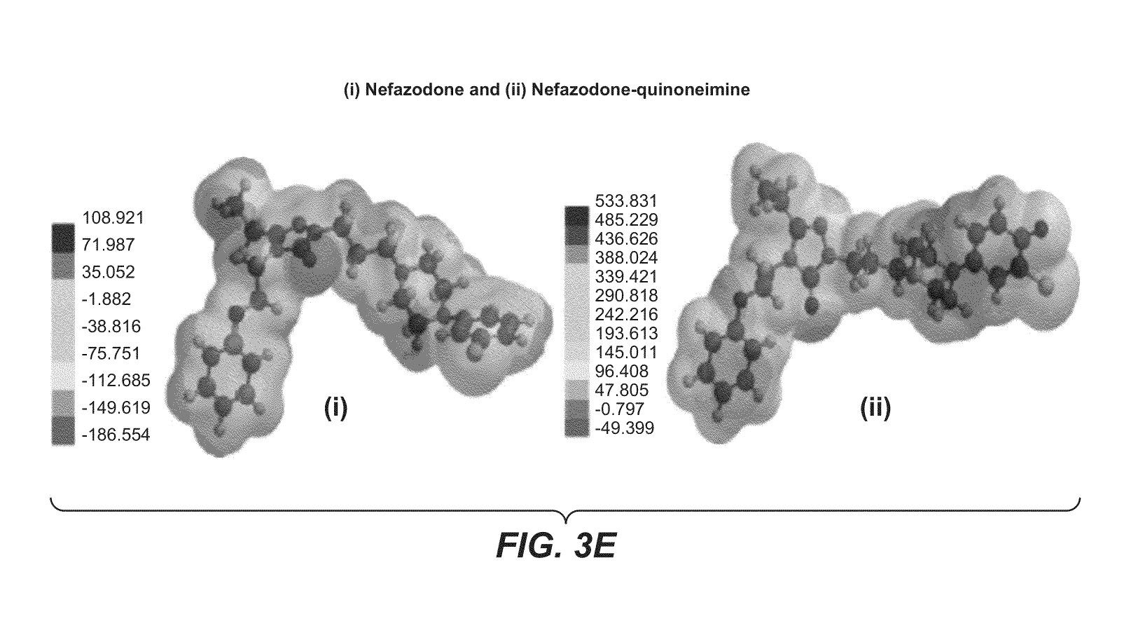

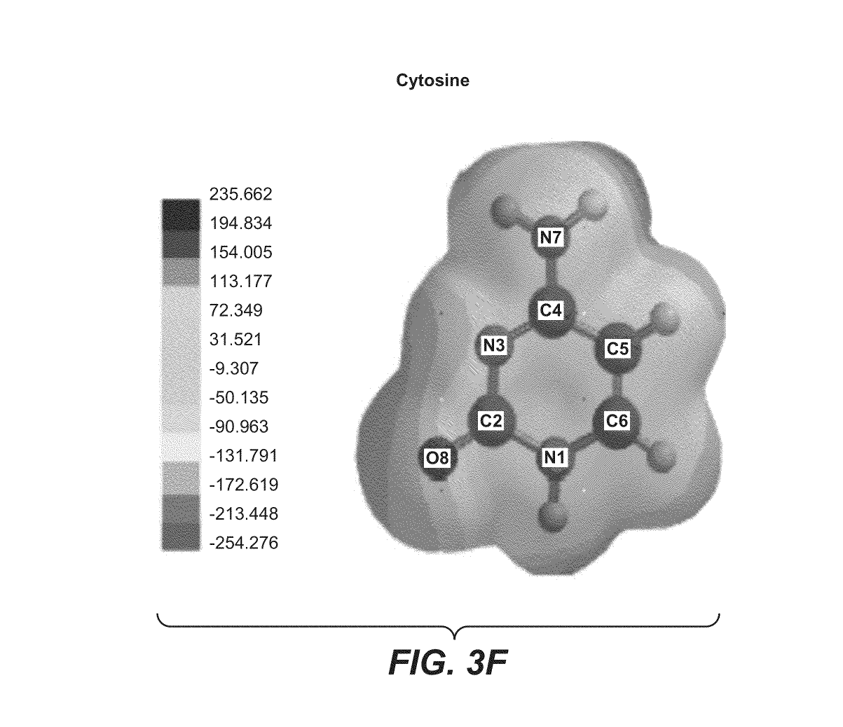

The phenylamine (aniline) group is a common structural component of many pharmaceutical compounds, including antibiotics and anesthetics (FIG. 1A). Data presented in FIG. 3A maps the ESP for aniline in its non-planar and planar configurations, computed from density functional theory (DFT) methods. The values of the contours are described in kJ/mol and the color scale is the same for both models. Importantly the ESP maps for aniline differ depending on the 3-dimensional configuration of the amine group. In the non-planar geometry, the unshared pair of electrons occupies an sp³ hybrid orbital of nitrogen and consequently the region of highest electron density is associated with nitrogen. In the planar geometry, on the other hand, nitrogen is sp²-hybridized, and the electron pair is delocalized between a p orbital of nitrogen and the π system of the ring.

The region of highest electron density in the non-planar configuration encompasses both the phenyl ring and the nitrogen of the amine group. Various reports have described that aniline adopts a non-planar configuration due to the more energetically favorable sp³-hybridized configuration^{74, 75} and consequently the non-planar ESP map could be considered to be the more energetically favorable representation.

These results demonstrated the importance of not simply relying on a ‘plug-and-play’ software approach in the construction of ESP maps and instead conveyed the necessity of employing optimized geometry and appropriate minimization in order to produce accurate and meaningful ESP maps.

The non-planar configuration of aniline creates sites of negative potential (red areas) above and below the aromatic ring (Vₘᵢₙ is −118.202 kJ/mol) and the amine (Vₘᵢₙ is −92.527 kJ/mol) which in part may help to provide a mechanistic basis for the observation of several N-conjugated Phase II metabolites (derived from the conjugation of electrophiles, such as the activated acetyl group, with the amine, in several mammalian species treated with, or exposed to aniline,⁷⁶ including humans.⁷⁷

The solvation energy of aniline (−21.68 kJ/mol) suggested that it is moderately soluble in water, as supported by experimental data (i.e., 0.04 g/mL).⁷⁸ Furthermore, as can be deduced from the differences in the heats of formation (ΔH_{f}^{⊖}) (−107.34 vs. 87.03 kJ/mol) and energies of solvation (−27.06 vs. −21.68 kJ/mol) for N-phenylacetamide and aniline respectively (see Table 1 below), the N-acetylated metabolite is more stabile and more water-soluble than aniline which may explain why N-acetylated metabolites are the major urinary metabolites of aniline observed in humans.⁷⁷ The N-phenylacetamide is slightly less reactive than aniline (E_{LUMO}-E_{HOMO}: 5.68 eV vs. 5.64 eV respectively) suggesting that aniline is rendered less reactive by N-acetylation.⁷⁹ In a similar way, halogenated anilines are conjugated by nucleophilic attack by glutathione, as was reported previously.⁸⁰

TABLE 1

| | | Energy of | | | E_{LUMO} − | |
|---|---|---|---|---|---|---|
| | ΔH_{f}^{θ}_{gas} | Solvation | E_{HOMO} | E_{LUMO} | E_{HOMO} | Weight of |
| Compound | (kJ/mol) | (kJ/mol) | (eV) | (eV) | (eV) | Evidence |
| ANILINE | | | | | | |
| aniline | 87.03 | −21.68 | −5.39 | 0.25 | 5.64 | — |
| N-phenylacetamide | −107.34 | −27.06 | −5.95 | −0.27 | 5.68 | 0 |

Predicted heats of formation, solvation energies, and E_{LUMO} − E_{HOMO} values for aniline and its principle metabolites

### Example 2

### Acetaminophen

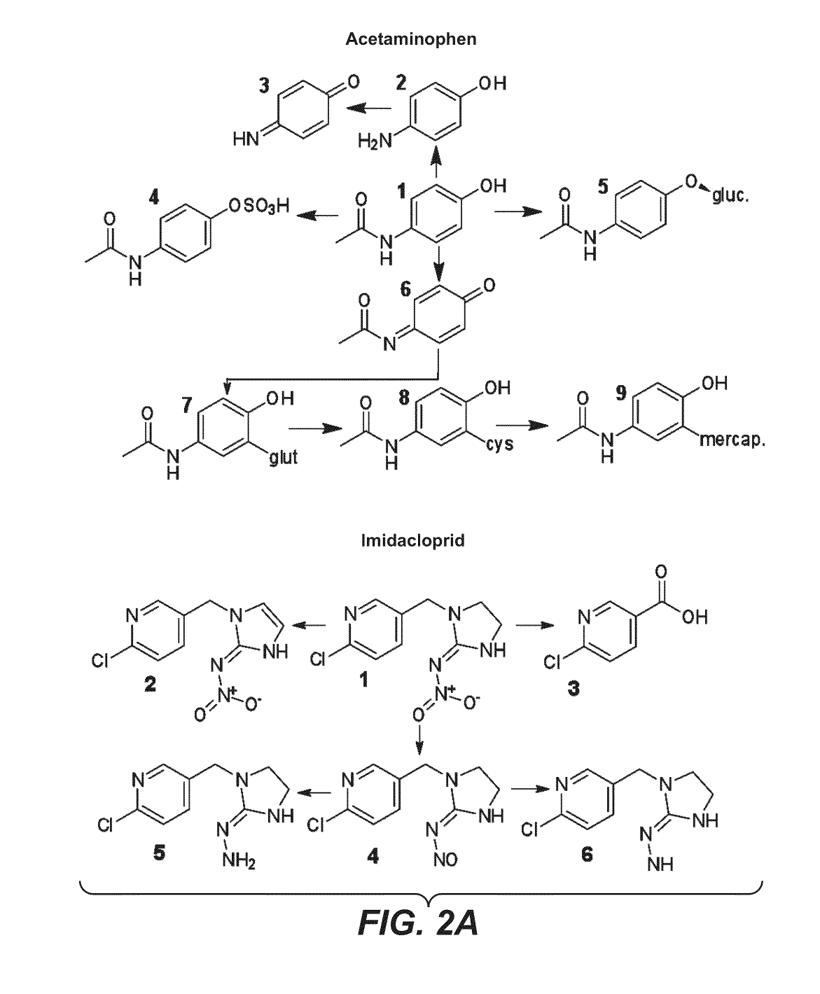

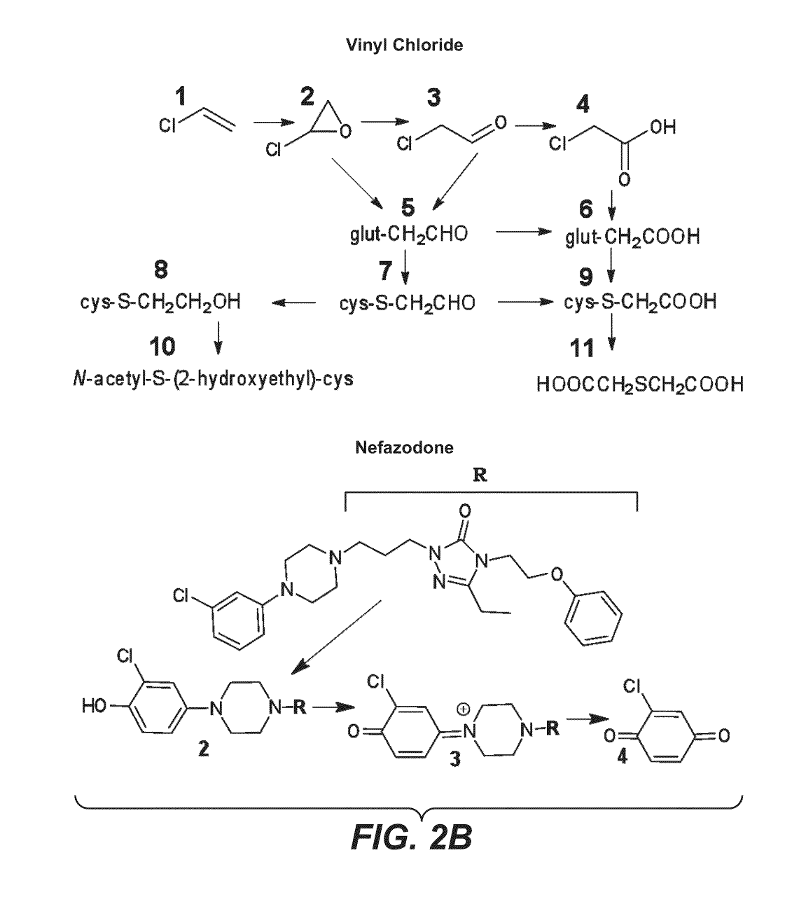

Acetaminophen (paracetamol; N-acetyl-para-aminophenol; FIG. 1B) is a widely-used analgesic and antipyretic drug, which upon overdosing may cause centrilolobular hepatic necrosis.^{81, 82} The metabolism of acetaminophen has been studied extensively in experimental animals and humans (FIG. 2).^{83, 84} The primary metabolites of acetaminophen in humans are Phase II metabolites formed by conjugation with sulfate and glucuronic acid to produce 4-acetamidophenol sulfate and 4-acetamidophenol glucuronide (metabolites 4 and 5 respectively).⁸⁵ N-acetyl-p-benzoquinoneimine (NAPQI; metabolite 6) is a bioactivated Phase I metabolite of acetaminophen and has been the subject of numerous toxicity studies because it causes hepatoxicity following acetaminophen overdose.⁸⁶⁻⁹⁰ Another bioactivated Phase I acetaminophen metabolite is para-quinoneimine (metabolite 3) which has been shown to be more reactive but less stable than NAPQI in vivo.^{91, 92}

The ΔH_{f}^{⊖}, solvation energies, and E_{LUMO}-E-_{HOMO} values (See Table 2 below) agree with experimental data which demonstrated that NAPQI and para-quinoneimine are bioactivation metabolites of acetaminophen.^{93, 94} The ΔH_{f}^{⊖} and solvation energies of acetaminophen (−276.67 and −43.49 kJ/mol respectively) both increase, due to metabolic processes, in going from para-aminophenol (−74.16 and −43.16 kJ/mol) to para-quinoneimine (52.28 and −29.69 kJ/mol) indicating the larger thermodynamic instability and decreased water solubility of the two quinoneimines. Decreased water solubility suggests that the two quinoneimines are unlikely to be excreted unchanged in urine (unlike acetaminophen, which can be excreted unchanged up to 9% of therapeutic dose),⁹⁵ and consequently they are predicted to require Phase II conjugation (such as with glutathione) in order to be excreted; this prediction is in agreement with experimental data. Metabolism of acetaminophen to these quinoneimines in excess of an adequate store of glutathione, is associated with hepatic failure.⁹⁶ The solvation energy of acetaminophen suggested that it is a moderately water soluble compound, which is supported by experimental data (i.e. 12.78 mg/mL at 20° C).⁹⁷

TABLE 2

| | | Energy of | | | E_{LUMO} − | |
|---|---|---|---|---|---|---|
| | ΔH_{f}^{θ}_{gas} | Solvation | E_{HOMO} | E_{LUMO} | E_{HOMO} | Weight of |
| Compound | (kJ/mol) | (kJ/mol) | (eV) | (eV) | (eV) | Evidence |
| ACETAMINOPHEN | | | | | | |
| acetaminophen (1) | −276.67 | −43.49 | −5.55 | −0.36 | 5.19 | — |
| para-aminophenol (2) | −74.16 | −43.16 | −4.99 | 0.12 | 5.11 | 3 |
| para-quinoneimine (3) | 52.28 | −29.69 | −6.07 | −2.80 | 3.27 | 3 |
| 4-acetamidophenol sulfate (4) | −744.79 | −79.76 | −6.59 | −1.09 | 5.5 | 0 |
| 4-acetamidophenol glucuronide (5) | −1317.66 | −76.68 | −6.14 | −0.61 | 5.53 | 0 |
| N-acetyl-p-benzoquinoneimine (6) | −227.48 | −28.88 | −7.04 | −3.43 | 3.61 | 3 |
| 3-(glutathionyl) acetaminophen (7) | −1339.17 | −224.26 | −5.82 | −0.74 | 5.08 | 1 |
| 3-(cysteinyl)-acetaminophen (8) | −614.72 | −74.19 | −5.91 | −0.83 | 5.08 | 1 |
| 3-acetaminophen mercapturic acid (9) | −802.00 | −70.32 | −6.02 | −0.95 | 5.07 | 1 |

Predicted heats of formation, solvation energies, and E_{LUMO} − E_{HOMO} values for acetaminophen, and its principle metabolites

The ESP maps for acetaminophen and NAPQI (FIG. 3B) clearly showed the presence of numerous electrophilic sites in NAPQI (as indicated by the blue regions; Vₘₐₓ is 119.945 kJ/mol) which are prone to nucleophilic attack by glutathione. E_{LUMO}-E-_{HOMO} values decrease from 5.19 eV (for acetaminophen) to 3.27 eV (for para-quinoneimine) and 3.61 eV (for NAPQI) indicating that the quinoneimines are more reactive than acetaminophen. As expected, the sulfate, glucuronide, cysteine, and mercapturic acid metabolites all have high solvation energies, and therefore they would be predicted to be very water-soluble and found in urine. These predictions are in agreement with their presence as acetaminophen metabolites in urine derived from experimental animal data.⁹⁸⁻¹⁰⁰

### Example 3

### Vinyl Chloride

Vinyl chloride (chloroethene) (FIG. 1C) is an organochlorine compound that is used extensively in the plastics industry during the synthesis of polyvinyl chloride (PVC). Vinyl chloride can cause angiosarcoma in humans and experimental animals and thus it is classified by International Agency for Research on Cancer (IARC) as a Class 1 compound which signifies that there are sufficient data to confirm that it is carcinogenic to humans.¹⁰¹

Vinyl chloride is metabolized primarily in the liver by CYP2E1 to the electrophilic Phase I metabolites chloroethylene oxide and chloroacetaldehyde (FIG. 2, metabolites 2 and 3 respectively) which can react with the nitrogenous bases of DNA to form mutagenic adducts, such as 1,N⁶-ethenoadenine.¹⁰² Thiodiglycolic acid (metabolite 11) is the major urinary metabolite for humans exposed to vinyl chloride.¹⁰³

The solvation energies and heats of formation (both in kJ/mol) for vinyl chloride and its metabolites are shown in Table 3 below. The solvation energies predicted that although vinyl chloride is fairly insoluble in water (1.62 kJ/mol), as verified by experimental data (i.e. 2.7 g/L),¹⁰⁴ all of its primary metabolites are soluble, including chloroacetaldehyde (−13.85 kJ/mol (predicted), ≧100 mg/mL (experimentally-derived);^{105, 106} thioglycolic acid (−28.28 kJ/mol (predicted), ≧100 mg/mL (experimentally-derived)¹⁰⁷) and a series of glutathione-derived metabolites, such as S-formylmethylglutathione (−217.24 kJ/mol).

TABLE 3

| | | Energy of | | | E_{LUMO} − | |
|---|---|---|---|---|---|---|
| | ΔH_{f}^{θ}_{gas} | Solvation | E_{HOMO} | E_{LUMO} | E_{HOMO} | Weight of |
| Compound | (kJ/mol) | (kJ/mol) | (eV) | (eV) | (eV) | Evidence |
| VINYL CHLORIDE | | | | | | |
| vinyl chloride (1) | 29.00 | 1.62 | −7.14 | −0.04 | 7.10 | — |
| chloroethylene oxide (2) | −58.14 | −26.37 | −7.96 | 0.56 | 8.52 | 0 |
| chloroacetaldehyde (3) | −174.68 | −13.85 | −7.56 | −1.40 | 6.16 | 1 |
| chloroacetic acid (4) | −431.23 | −24.46 | −7.84 | −0.91 | 6.93 | 1 |
| S-formylmethylglutathione (5) | −955.68 | −217.24 | −6.81 | −1.29 | 5.52 | 1 |
| S-carboxymethylglutathione (6) | −1489.69 | −94.78 | −6.62 | −0.82 | 5.80 | 1 |
| S-formylmethylcysteine (7) | −501.58 | −37.62 | −6.50 | −0.72 | 5.78 | 1 |
| S-(2-hydroxyethyl)-cysteine (8) | −631.40 | −63.27 | −6.24 | 0.04 | 6.28 | 1 |
| S-carboxymethylcysteine (9) | −776.69 | −53.20 | −6.34 | −0.45 | 5.89 | 1 |
| N-acetyl-S-(2-hydroxyethyl)-cysteine | −782.35 | −63.07 | −6.37 | −0.04 | 5.97 | 1 |
| (10) | | | | | | |
| thioglycolic acid (11) | −381.18 | −28.28 | −6.74 | −0.34 | 6.40 | 1 |

Predicted heats of formation, solvation energies, and E_{LUMO} − E_{HOMO} values for vinyl chloride and its principle metabolites

The heats of formation for chloroethylene oxide (−58.14 kJ/mol) vs. chloroacetaldehyde (−174.68 kJ/mol) suggest that the latter metabolite is much more stable than the former. This observation is in agreement with experimental data which have shown that chloroethylene oxide can spontaneously rearrange to form chloroacetaldehyde. The larger E_{LUMO}-E_{HOMO} differences for vinyl chloride (7.1 eV) and chloroethylene oxide (8.52 eV) suggested that these compounds are less reactive than the other metabolites and that they require metabolic conversion in order to become bioactivated. The smaller E_{LUMO}-E_{HOMO} difference for chloroacetaldehyde (6.16 eV) vs. chloroethylene oxide indicates that chloroacetaldehyde is more reactive than chloroethylene oxide so that the former can form adducts with DNA more easily, in agreement with experimental data.

In the case of chloroacetaldehyde, the position of most negative ESP is located on the oxygen atom (Vₘᵢₙ is −128.528 kJ/mol), meaning that this area is subject to electrophilic attack (FIG. 3C). On the other hand, the carbon to which the chlorine is attached is the most positive ESP region of the molecule (Vₘₐₓ is 145.814 kJ/mol) and is the site that is most prone to nucleophilic attack. The predicted nucleophilic attack of chloroacetaldehyde at the carbon with the most positive ESP was in agreement with experimental data which confirmed that a glutathione-derived metabolite, thiodiglycolic acid, is the primary urinary metabolite of chloroacetaldehyde and vinyl chloride in rats and occupational workers.¹⁰⁵⁻¹⁰⁹

### Example 4

### Nefazodone

Nefazodone (Serzone; Nefadar; 1-(3-[4-(3-chlorophenyl)piperazin-1-yl]propyl)-3-ethyl-4-(2-phenoxyethyl)-1H-1,2,4-triazol-5(4H)-one; FIG. 1D) is an antidepressant first marketed by Bristol-Myers Squibb in 1994. Its antidepressant properties are due primarily to its role as a potent antagonist at the 5-HT_{2A} receptors (K_{d}: 26 nM).¹¹⁰ Nefazodone was withdrawn from the market in 2004 due to reports of adverse hepatic events, including jaundice, hepatitis and hepatocellular necrosis.¹¹¹ The hepatotoxicity effects are believed to be due to the formation of an electrophilic quinoneimine metabolite (metabolite 3; FIG. 2).¹¹²

The metabolism of Nefazodone has been described previously.¹¹³ Briefly aromatic hydroxylation occurs para to the piperazinyl nitrogen to produce p-hydroxynefazodone (metabolite 2; FIG. 2) by CYP2D6.¹¹⁴ Rearrangement of metabolite 2 leads to the formation of the reactive quinoneimine (metabolite 3) and N-dearylation forms 2-chlorocyclohexa-2,5-diene-1,4-dione (metabolite 4).

The solvation energy of Nefazodone was calculated to be −3.15 kJ/mol which suggests that it has low water-solubility, in agreement with experimental data (6.41 mg/L at pH 7).¹¹⁵ The solvation energies of the metabolites of Nefazodone (see Table 4 below) are all predicted to be more water-soluble than the parent. The E_{LUMO}-E_{HOMO} value for Nefazodone (5.17 eV) is greater than for the other compounds signifying that the compound gives rise to metabolites that are more reactive than the parent compound during its biotransformation. Not surprisingly the two quinone metabolites (metabolites 3 and 4) have the lowest E_{LUMO}-E_{HOMO} value (4.18 eV and 3.88 eV respectively) indicating that they are expected to be more reactive compounds than Nefazodone. Metabolite 4 had the lowest ΔH_{f}^{⊖} (−279.56 kJ/mol) signifying that it is likely to be stable (in agreement with reported data)¹¹⁶ and the least labile of the metabolites.

TABLE 4

| | | Energy of | | | E_{LUMO} − | |
|---|---|---|---|---|---|---|
| | ΔH_{f}^{θ}_{gas} | Solvation | E_{HOMO} | E_{LUMO} | E_{HOMO} | Weight of |
| Compound | (kJ/mol) | (kJ/mol) | (eV) | (eV) | (eV) | Evidence |
| NEFAZODONE | | | | | | |
| Nefazodone (1) | 145.94 | −3.15 | −5.28 | −0.11 | 5.17 | — |
| Nefazodone-hydroxy (2) | −31.37 | −49.00 | −5.01 | −0.24 | 4.97 | 1 |
| Nefazodone-quinoneimine (3) | 831.42 | −207.85 | −9.51 | −4.13 | 4.18 | 2 |
| chlorobenzoquinone (4) | −279.56 | −17.25 | −7.67 | −3.79 | 3.88 | 1 |

Predicted heats of formation, solvation energies, and E_{LUMO} − E_{HOMO} values for Nefazodone and its principle metabolites

In contrast, metabolite 3 has the highest ΔH_{f}^{⊖} (831.42 kJ/mol) indicating that it is relatively unstable and likely prone to nucleophilic attack (e.g. by GSH). This is further supported by the ESP map for metabolite 3 which shows a large area of positive ESP (blue color) near and above the charged nitrogen of the piperazine ring (N^{|}), with a large Vₘₐₓ of 533.831 kJ/mol, indicating that this region is particularly prone to nucleophilic attack (FIG. 3). Glutathione conjugates of metabolite 3 have been reported in the literature in support of these ESP-based predictions.¹¹⁷

### Example 5

### Imidacloprid

Imidacloprid (N-[1-[(6-Chloro-3-pyridyl)methyl]-4,5-dihydroimidazol-2-yl]nitramide; FIG. 1E), the world's best-selling pesticide,¹¹⁸ is a systemic insecticide that is used to control insect populations in crops and for flea control in cats and dogs. It belongs to a family of insecticides called the neonicotinoids which act as potent agonists for the insect nicotinic acetylcholine receptor (nAChR); blockage of ACh transmission in the insect leads to rapid death.¹¹⁹ The >500-fold selectivity of imidacloprid for the insect (IC₅₀: 4.6 nM) vs. the α₄β₂ mammalian nAChR (IC₅₀: 2600 nM) is based, to a large extent, on the ESP of the molecule: an overall negative ESP at the ‘tip’ of imidacloprid, as provided by the presence of the nitro group, is required in order for binding to the insect nAChR to occur. The negative ESP of the imidacloprid tip (red area) is shown in FIG. 3D. The selectivity in binding is due to key differences in amino acids at the active sites of the nAChRs: the insect nAChR contains numerous key cationic amino acids (to which the negative tip is attracted) whereas the active site of the mammalian nAChR contains numerous key anionic amino acids (which repel the negative tip).¹²° However when imidacloprid is metabolized to its guanidine metabolite (imidacloprid-NH; FIG. 2) the ESP of the tip changes from negative to positive, as confirmed by the positive ESP (blue color) in FIG. 3D. The result is that the guanidine metabolite is selective for the mammalian α4β2 nAChR (IC₅₀: 8.2 nM) instead of the insect nAChR (IC₅₀: 1530 nM). Thus, although the 3-dimensional structures of imidacloprid and its guanidine metabolite are very similar this example clearly demonstrates how ESP can directly influence pharmacology and can play a role in determining selective toxicity between organisms. This ESP assessment is in full agreement with electrostatic calculations performed by other research groups.¹²¹

The metabolism, toxicology and pharmacokinetics of imidacloprid in plants and mice have been described by the author and colleagues previously.¹²²⁻¹²⁶ Briefly, upon absorption, imidacloprid is metabolized via dehydration across the ethano-bridge of the imidazaolidine ring to form an olefin compound (metabolite 2). Reduction of the nitro group yields a nitroso metabolite (metabolite 4) which is further reduced to aminoguanidine and guanidine metabolites (metabolites 5 and 6, respectively). N-methylene hydroxylation leads to the formation of 6-chloro-nicotinic acid (metabolite 3).

The solvation energy of imidacloprid was calculated to be −51.98 kJ/mol which suggests that it is a water-soluble compound, in support of experimental data (0.61 g/L at 20° C).¹²⁷ The solvation energies of the metabolites of imidacloprid (see Table 5 below) are all predicted to be more water-soluble than the parent; this prediction is in agreement with experimental data which demonstrate that these metabolites are found to a greater extent in the urine of imidacloprid-treated mice and rats than the parent compound.^{123, 128} The E_{LUMO}-E_{HOMO} value for imidacloprid (5.49 eV) is greater than for the other compounds, with the exception of metabolite 3 (5.53 eV). Not surprisingly the nitrosamine metabolite (metabolite 4) had the lowest E_{LUMO}-E_{HOMO} value (4.1 eV) implying that this metabolite would be expected to be a more reactive compound than imidacloprid (indicating bioactivation). In addition metabolite 3 had the lowest ΔH_{f}^{⊖} (−275.33 kJ/mol) suggesting that it is likely to be the most stable and least labile of the metabolites, in full agreement with experimental data.¹²⁷

TABLE 5

| | | Energy of | | | E_{LUMO} − | |
|---|---|---|---|---|---|---|
| | ΔH_{f}^{θ}_{gas} | Solvation | E_{HOMO} | E_{LUMO} | E_{HOMO} | Weight of |
| Compound | (kJ/mol) | (kJ/mol) | (eV) | (eV) | (eV) | Evidence |
| IMIDACLOPRID | | | | | | |
| imidacloprid (1) | 222.37 | −51.98 | −6.97 | −1.48 | 5.49 | — |
| imidacloprid-olefin (2) | 489.32 | −72.41 | −6.29 | −1.27 | 5.02 | 2 |
| 6-chloro-nicotinic acid (3) | −275.33 | −62.14 | −7.46 | −1.93 | 5.53 | 0 |
| Imidacloprid-NNO (4) | 280.35 | −86.20 | −5.46 | −1.36 | 4.10 | 2 |
| imidacloprid-NNH₂ (5) | 333.89 | −59.04 | −5.37 | −0.89 | 4.48 | 2 |
| imidacloprid-NH (6) | 372.27 | −55.34 | −6.00 | −0.84 | 5.16 | 2 |

Predicted heats of formation, solvation energies, and E_{LUMO} − E_{HOMO} values for imidacloprid and its principle metabolites

### Example 6

### Using ESP to Predict Mutagenic Potential of Molecules

As illustrated by the 5 diverse examples described above, an important characteristic of ESP is that it is a discreet and measurable physicochemical property of a molecule, as demonstrated by the fact that it can be determined experimentally.^{129, 130} ESP, as defined by Equation 6, has an important physical significance: it describes the overall electrostatic effect of the electrons and nuclei of a molecule in their surrounding space. By defining the electrostatic signatures of molecules ESP offers enormous potential in studying and improving interactions of small molecules, including those of medicinal interest, with biological systems of importance. As an example of its utility in improving genotoxicity screening of candidate drug molecules the role played by ESP in predicting the mutagenic potential and chemical carcinogenesis of molecules is described in this section.

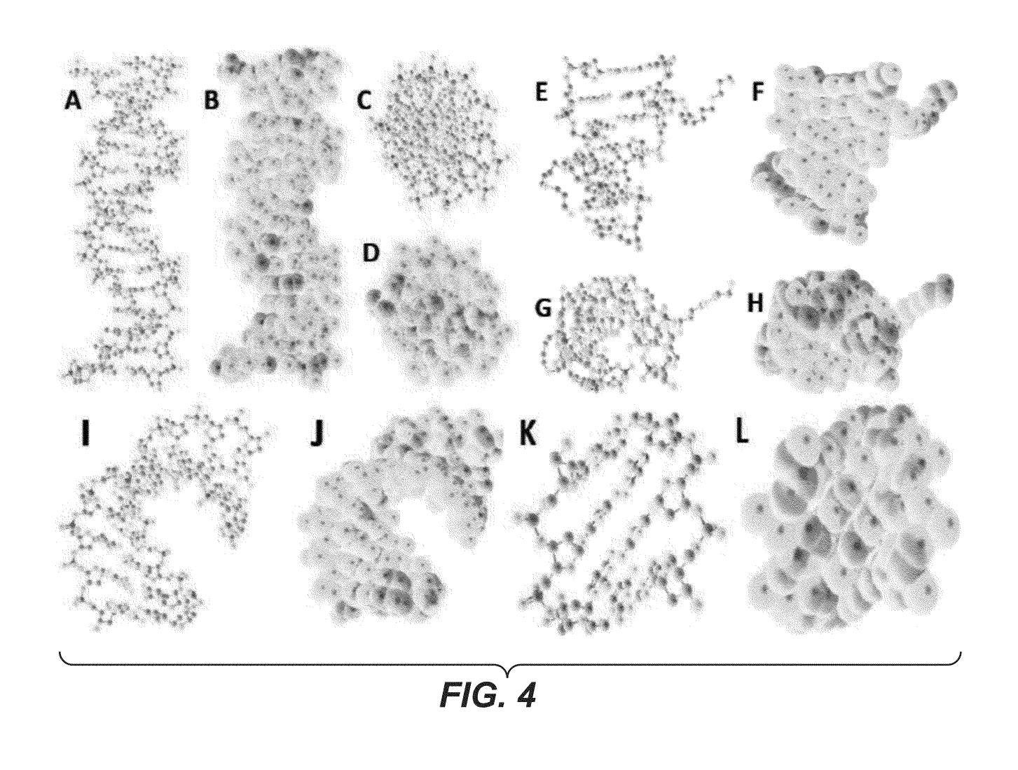

Electrostatic effects in DNA can be quite different from those in proteins due to the negative charges of the phosphate back-bone of DNA which contributes to an overall negative ESP, as shown for A-, B- and Z-configurations of DNA (red color in FIG. 4). The negative charge of DNA attracts counterions which help stabilize the tertiary structure of the polymer¹³¹; however positively-charged electrophiles are also attracted by the negative ESP which can lead to the formation of highly mutagenic adducts.¹³²⁻¹³⁴ The ESP of cytosine is discussed as follows in order to illustrate the application of ESP in the prediction of chemical mutagenicity.

Cytosine (4-aminopyrimidin-2(1H)-one; FIG. 1F) is one of the four main bases found in DNA and RNA. In Watson-Crick base pairing, cytosine interacts with guanine via 3H-bonds. The ESP map for cytosine shows a region of negative potential near both N³ and O⁸ which provides two Vₘᵢₙ (i.e. regions to which an electrophile is predicted to be most strongly attracted) (FIG. 3F): one of these is near N³, where the potential reaches a value of −115.3 kJ/mol, and the other is near O⁸, with a potential of −148.9 kJ/mol. There is also a much weaker region of negative potential near the amine nitrogen, N⁷, with a Vₘᵢₙ of −67.1 kJ/mol. From the ESP map, it would be predicted that an electrophile would preferentially attack cytosine at the N³ and O⁸ positions, which is what is found to occur experimentally. N³ is the preferred site for alkylation reactions by electrophiles.¹³⁵ When N³ is not accessible, as in DNA (in which it is involved in hydrogen bonding), some electrophiles have been observed to react instead with O.^{8, 136} Thus, cytosine, chosen here as an example, was observed experimentally to behave toward electrophiles in exactly the manner that would be predicted from its ESP map.

### Example 7

### Computing System

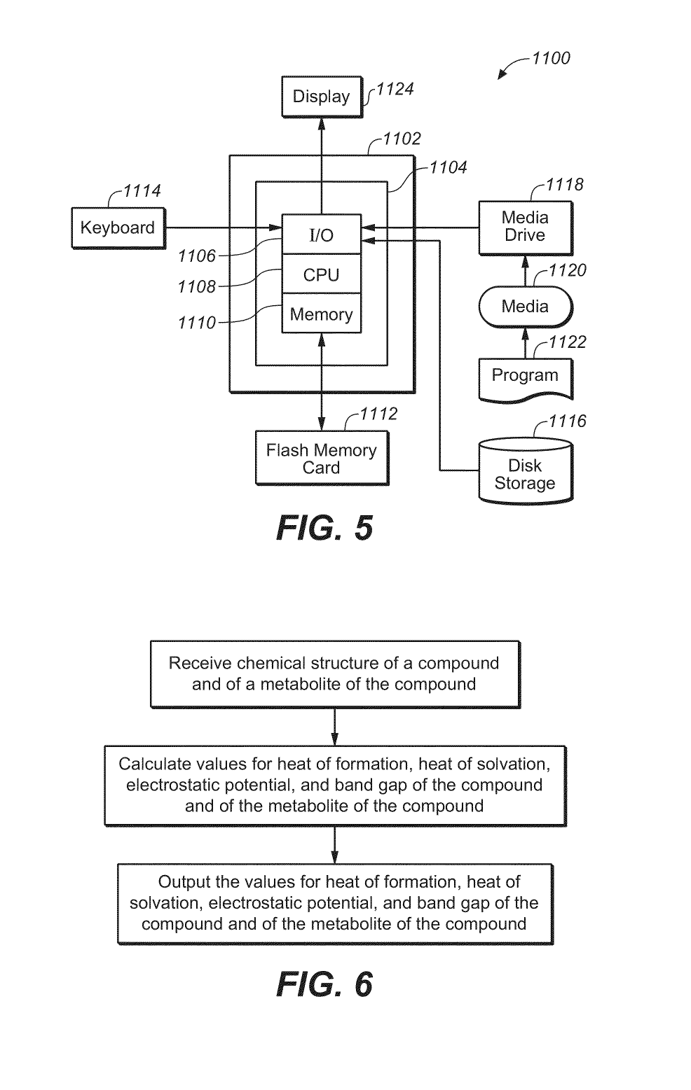

FIG. 5 depicts an exemplary computing system 1100 configured to perform any one of the above-described processes. In this context, computing system 1100 may include, for example, a processor, memory, storage, and input/output devices (e.g., monitor, keyboard, disk drive, Internet connection, etc.). However, computing system 1100 may include circuitry or other specialized hardware for carrying out some or all aspects of the processes. In some operational settings, computing system 1100 may be configured as a system that includes one or more units, each of which is configured to carry out some aspects of the processes either in software, hardware, or some combination thereof.

FIG. 5 depicts computing system 1100 with a number of components that may be used to perform the above-described processes. The main system 1102 includes a motherboard 1104 having an input/output (“I/O”) section 1106, one or more central processing units (“CPU”) 1108, and a memory section 1110, which may have a flash memory card 1112 related to it. The I/O section 1106 is connected to a display 1124, a keyboard 1114, a disk storage unit 1116, and a media drive unit 1118. The media drive unit 1118 can read/write a computer-readable medium 1120, which can contain programs 1122 and/or data.

At least some values for heat of formation, heat of solvation, electrostatic potential, and band gap for a compound and a metabolite of the compound based on the results of the above-described processes and methods can be saved for subsequent use. Additionally, a non-transitory computer-readable medium can be used to store (e.g., tangibly embody) one or more computer programs for performing any one of the above-described processes and methods by means of a computer. The computer program may be written, for example, in a general-purpose programming language (e.g., Pascal, C, C++, Java) or some specialized application-specific language.

Although only certain exemplary embodiments have been described in detail above, those skilled in the art will readily appreciate that many modifications are possible in the exemplary embodiments without materially departing from the novel teachings and advantages of the instant invention. For example, aspects of embodiments disclosed above can be combined in other combinations to form additional embodiments. Accordingly, all such modifications are intended to be included within the scope of this invention. The descriptions and examples should not be construed as limiting the scope of the invention. The disclosures of all patent and scientific literature cited herein are expressly incorporated in their entirety by reference.

### REFERENCES

1. Benigni, Mutagenesis 1991, 6, 423-425.

2. Fjodorova et al., Chem. Cent. J. 2010, 4 Suppl. 1, S3.

3. Filz et al., SAR QSAR Environ. Res. 2008, 19, 81-90.

4. Keseru, Bioorg. Med. Chem. Lett. 2003, 13, 2773-2775.

5. Kuroda and Saito, Toxicol. In Vitro. 2010, 24, 661-668.

6. Lowe et al., Mol. Pharmaceutics 2010, 7, 1708-1714.

7. U.S. Department of Health and Human Services Food and Drug Administration Center for Drug Evaluation and Research (CDER). Guidance for Industry Genotoxic and Carcinogenic Impurities in Drug Substances and Products: Recommended Approaches. 2008.

8. European Medicines Agency. Committee for Medicinal Products for Human Use (CHMP) Safety Working Party (SWP). Questions and answers on the ‘Guideline on the limits of genotoxic impurities’. 2007, Rev. 3, 431994.

9. Linget and Vignard, J. Pharm. Biomed. Anal. 1999, 19, 893-901.

10. Wynalda and Wienkers, Drug Metab. Dispos. 1997, 25, 1211-1214.

11. Ekins et al., J. Pharmacol. Toxicol. Methods 2000, 44, 313-324.

12. Meteor Software Brochure, Lhasa Ltd., Leeds, U.K. https://www.lhasalimited.org/meteor/ (accessed August 2012).

13. Metasite Software, Molecular Discovery Brochure, Molecular Discovery, Perugia, Italy. http://www.moldiscovery.com/soft_metasite.php/ (accessed August 2012).

14. Ekins et al., Expert Opin. Drug Metab. Toxicol. 2005, 1, 303-324.

15. Meanwell, Chem. Res. Toxicol. 2011, 24, 1420-1456.

16. Adamson et al., Physical Chemistry of Surfaces, 6th ed.; Adamson, A. W.; Gast, A. P., Eds.; John Wiley and Sons: New York, 1997; pp 784.

17. Sivasankar et al., Proc. Natl. Acad. Sci. U.S.A. 1998, 95, 12961-12966.

18. Sivasankar et al., Biophys. J. 2001, 80, 1758-1768.

19. Poisson, Nouveau Bull. Soc. Philomathique de Paris, 1813, 3, 388-392.

20. Coulomb, Histoire de l'Academie Royale des Sciences 1785, 569-577.

21. Gao et al., Science 1996, 272, 535-537.

22. Politzer and Truhlar, In Chemical Applications of Atomic and Molecular Electrostatic Potentials. Politzer, P.; Truhlar, D. G. Eds.; Plenum Press, New York, 1981; pp. 1-6.

23. Scrocco and Tomasi, J. Adu. Quantum Chem. 1978, 11, 115.

24. Politzer and Daiker, In The Force Concept in Chemistry; Deb, B. M., Ed.; Van Nostrand Reinhold: New York, 1981; p 294.

25. Ingold, Recl. Tray. Chim. Pays-Bas. 1929, 48, 797-812.

26. Politzer and Murray, Theor. Chem. Accts, 2002, 108, 134.

27. Jin et al., Int. J. Quantum Chem, 2004, 96, 394.

28. Politzer, Theor. Chem. Accts. 2004, 111, 395-399.

29. Moller and Plesset, Phys. Rev. 1934, 46, 618-622.

30. Cohen and Dalgarno, Proc. Phys. Soc. 1961, 77, 748-750.

31. Pople and Seeger, J. Chem. Phys. 1975, 62, 4566.

32. Perahia et al., Theoret. Chim. Acta 1975, 40, 47-60.

33. Catalan and Yanez, J. Am. Chem. Soc. 1978, 100, 1398-1401.

34. Petrongolo et al., Petrongolo, Internat. J. Quantum Chem. 1978, 13, 457-468.

35. Bentley, J. Chem. Phys. 1979, 70, 159-164.

36. Fink and Bonham, Electrostatic potentials of free molecules derived from electron diffraction results. In: Chemical Applications of Atomic and Molecular Electrostatic Potentials. Politzer, P.; Truhlar, D. G.; Eds.; Plenum Press: New York, 1981; pp. 93-122.

37. Truhlar, Effective potentials for intermediate-energy electron scattering: testing theoretical models. In: Chemical Applications of Atomic and Molecular Electrostatic Potentials. Politzer, P.; Truhlar, D. G.; Eds.; Plenum Press: New York, 1981; pp. 123-172.

38. Gitlin et al., Angew. Chem., Int. Ed. 2006, 45, 3022-3060.

39. Russell et al., J. Mol. Biol. 1987, 193, 803-813.

40. Louro et al., FEBS Letters. 2004, 576, 77-80.

41. Lee et al., Protein Sci. 2002, 11, 1004-1016.

42. Loewenthal et al., J. Mol. Biol. 1993, 232, 574-583.

43. Allewell land Oberoi, Methods Enzymol. 1991, 202, 3-19.

44. Kumar and Nussinov, Biophys. J. 2002, 83, 1595-1612.

45. Kumar and Nussinov, ChemBioChem. 2002, 3, 604-617.

46. Jeffery, Food Chem. 1996, 56, 241-246.

47. Thomas et al., Nature. 1985, 318, 375-376.

48. Jackson and Fersht, Biochemistry. 1993, 32, 13909-13916.

49. Laurents et al., J. Mol. Biol. 2003, 325, 1077-1092.

50. Scrocco and Tomasi, In: Topics in Current Chemistry. Scrocco, E.; Tomasi, J., Eds.; Springer-Verlag: Berlin, 1973; p. 95.

51. Pathak and Gadre, J. Chem. Phys. 1990, 93, 1770-1773.

52. Bonaccorsi et al., J. Chem. Phys. 1970, 52, 5270-5284.

53. Kushwaha and Mishra, J. Molec. Struct.-Theochem. 2003, 636, 149-156.

54. Collins and Workman, Nature Chem. Biol. 2006, 2, 689-700.

55. Pomamacka et al., Acta Pol. Pharm. 2004, 61, 461-466.

56. Makhija and Kulkami, J. Comput. Aided Mol. Des. 2001, 15, 961-978.

57. Chidangil and Mishra, J. Mol. Model. 1997, 3, 172-181.

58. Kumar and Mishra, J. Molec. Structure: Theochem. 1992, 277, 299-312.

59. Fazlul, J. Pharmacol. Toxicol. 2008, 3, 27-33.

60. Heimstad et al., Eur. Neuropsychopharmacol. 1991, 1, 127-137.

61. Bhattacharjee, J. Molec. Structure: Theochem. 2000, 529, 193-201.

62. Karle et al., J. Chem. Crystallogr, 2002, 32, 133-139.

63. Holstein et al., Cryst. Eng. Comm. 2012, 14, 2520-2531.

64. Naz et al., Pak. J. Pharm. Sci. 2009, 22, 78-82.

65. Jayasuriya and Williams, Int. J. Quantum Chem. 1986, 30, 265-273.

66. Murray et al., Int. J. Quantum Chem., 1998, 70, 1137-1143.

67. Chakrabarty, An Introduction to Physical Chemistry. 1st ed.; Chakrabarty, D. K., Ed.; Alpha Science: Mumbai. 2001; 409 pages.

68. Anslyn, and Dougherty, Modern Physical Organic Chemistry. 6th ed.; Anslyn, E. V.; Dougherty, D. A., Eds.; University Science: Sausalito. 2005; 1104 pages.

69. Fleming, Molecular Orbitals and Organic Chemical Reactions. 1st ed.; Fleming, I., Ed.; John Wiley and Sons: New York, 2010, 526 pages.

70. Gaussian 09, Revision A.1, Frisch, et al., Gaussian, Inc., Wallingford Conn., 2009.

71. Spartan '10 User Manual. Wavefunction. http://downloads.wavefun.com/Spartan10Manual.pdf (accessed August 2012).

72. Schmidt et al., J. Comput. Chem. 1993, 14, 1347-1363.

73. Avogadro: an open-source molecular builder and visualization tool. Version 1.0.3.

74. Bludsky et al., J. Chem. Phys. 1996, 105, 11042.

75. Brand et al., J. Molec. Spectrosc. 1966, 20, 193-195.

76. Kao et al., Drug Metab. Dispos. 1978, 6, 549-555.

77. Iwersen-Bergmann and Schmoldt, Int. J. Legal Med. 2000, 113, 171-174.

78. CDC-NIOSH pocket guide to chemical hazards. Aniline (and homologs). 2011. http://www.cdc.gov/niosh/npg/npgd0033.html (accessed August 2012).

79. Parkinson and Ogilvie, Biotransformation of Xenobiotics. In: Casarett and Doull's Toxicology: The Basic Science of Poisons, 7th ed.; Klaassen, C. D., Ed.; McGraw-Hill: New York, 2010; pp 161-305.

80. Chenghonget al., Chem. Res. Toxicol. 2011, 24, 1668-1677.

81. James et al., Lancet 1975, 27, 579-581.

82. Hinson et al., Handb. Exp. Pharmacol. 2010, 196, 369-405.

83. Smolarek et al., Drug Metab. Dispos. 1990, 18, 659-663.

84. Mitchell et al., J. Pharmacol. Exp. Ther. 1973, 187, 185-194.

85. Johnson and Plumb, J. Pharm. Biomed. Anal. 2005, 39, 805-810.

86. Prescott, J. Pharm. Sci. 1963, 52, 864-868.

87. Forrest et al., Clin. Pharmacokinet. 1982, 7, 93-107.

88. Miner and Kissinger, Biochem. Pharmacol. 1979, 28, 3285-3290.

89. Corcoran et al., Mol. Pharmacol. 1980, 18, 536-542.

90. Holme et al., Biochem. Pharmacol. 1984, 33, 401-406.

91. Dahlin et al., Proc. Natl. Acad. Sci. U.S.A. 1984, 81, 1327-1331.

92. Albano et al., Mol. Pharmacol. 1985, 28, 306-311.

93. Van de Straat et al., Chem.-Biol. Znteract. 1988, 64, 267-280.

94. Rush et al., CRC Crit. Rev. Toxicol. 1984, 13, 99-160.

95. Zenser and Davis, Fundam. Appl. Toxiol. 1984, 4, 922-929.

96. Laine et al., Xenobiotica 2009, 39, 11-21.

97. A Pharmacologic Overview of TYLENOL® (acetaminophen). http://www.tylenolprofessional.com/pharmacology.html (accessed August, 2012).

98. Albano et al., Molec. Pharmacol. 1985, 28, 306-311.

99. Granberg and Rasmuson, J. Chem. Eng. Data 1999, 44, 1391-1395.

100. National Toxicology Program. Toxicology and Carcinogenesis Studies of Acetaminophen (CAS No. 103-90-2) in F344/N Rats and B6C3F1 Mice (Feed Studies). 1993. Tech. Rep. Ser. No. 394; NIH Publ. No. 93-2849.

101. IARC monographs on the evaluation of carcinogenic risks to humans overall evaluations of carcinogenicity: an updating of IARC monographs volumes 1 to 42. 1987. Suppl. 7. http://monographs.iarc.fr/ENG/Monographs/suppl7/suppl7.pdf.

102. Guengerich et al., Chem. Res. Toxicol. 1991, 4, 168-179.

103. Cheng et al., J. Occup. Environ. Med. 1991, 43, 934-938.

104. National Toxicology Program's Chemical Solubility Compendium. Walters, D. B.; Keith, L. H., Eds.; 1991. CRC Pr: Ann Arbor. 448 pages.

105. El Ghissassi et al., Biochem. Pharmacol. 1998, 55, 1445-1452.

106. Jun-Hyuk and Pfeifer, Mutat. Res. 2004, 568, 245-256.

107. Muller et al., Int. Arch. Occup. Environ. Health 1976, 38, 69-75.

108. Muller et al., Int. Arch. Occup. Environ. Health 1978, 41, 199-205.

109. Muller et al., Int. Arch. Occup. Environ. Health, 1979, 44, 185-191.

110. Cusack et al., Psychopharmacol. (Berl.) 1994, 114, 559-565.

111. Rxlist.com: Nefazodone Prescribing Information. http://www.rxlist.com/serzone-drug.htm (accessed August 2012).

112. Kalgutkar et al., Drug Metab. Dispos. 2005, 33, 243-253.

113. Rotzinger and Baker, Eur. Neuropsychopharmacol. 2002, 12, 91-100.

114. Rotzinger et al., Biol. Psychiatry, 1998, 44: 1185-1191.

115. Nefazodone Hydrochloride MSDS. Santa Cruz Biotechnology. 2008. http://datasheets.scbt.com/sc-203156.pdf (accessed August 2012).

116. Fisher Scientific. Material Safety Data Sheet. 2-Chloro-1,4-benzoquinone. 2008. https://fscimage.fishersci.com/msds/99615.htm. (accessed August 2012).

117. Bauman et al., Drug Metab. Dispos. 2008, 36, 1016-29.

118. Nauen and Bretschneider, Pestic. Outlook 2002, 12, 241-245.

119. Tomizawa and Casida, Annu. Rev. Pharmacol. Toxicol. 2005, 45, 247-268.

120. Talley et al., Proc. Natl. Acad. Sci. USA 2008, 105, 7606-7611.

121. Le Questel et al., Bioorg. Med. Chem. 2011, 19, 7623-7634.

122. Ford et al., Proc. Natl. Acad. Sci. USA, 2010, 107, 17527-17532.

123. Ford and Casida, Chem. Res. Toxicol. 2006, 19, 944-951.

124. Ford and Casida, J. Agric. Food Chem. 2008, 56, 10168-10175.

125. Shi et al., J. Agric. Food Chem. 2009, 57, 4861-4866.

126. Ford et al., J. Agric. Food Chem. 2011, 59, 4860-4867.

127. Krohn, Water Solubility of Imidacloprid. Bayer AG, Report No. PC320. 1993. Unpublished., as referenced in: http://www.fao.org/ag/AGP/AGPP/Pesticid/JMPR/Download/2002_eva/IMIDA_EVjjb.pdf (accessed August 2012).

128. Solecki and Inchem, Toxicological evaluations for imidacloprid. 2001. http://www.inchem.org/documents/jmpr/jmpmono/2001pr07.htm (accessed August 2012).

129. Bentley, J. Chem. Phys. 1979, 70,159-164.

130. Spackman and Stewart, Electrostatic potentials in crystals. In: Chemical Applications of Atomic and Molecular Electrostatic Potentials. Politzer, P.; Truhlar, D. G., Eds.; Plenum Press: New York, 1981; pp. 407-426.

131. Várnai and Zakrzewska, Nucleic Acids Res. 2004, 32, 4269-4280.

132. Chaudhary et al., Science 1994, 265, 1580-1582.

133. Lindahl, Nature. 1993, 22, 709-715.

134. Ames and Gold, Mutat Res., 1991, 250, 3-16.

135. Brookes and Lawley, J. Chem. Soc. 1962, 254, 1348-1351.

136. Dove et al., Biochem. Biophys. Res. Commun. 1959, 1, 312-317.

What is claimed is:

1. A computer implemented method for predicting bioactivation of a compound and of a metabolite of the compound, the method comprising:
(a) receiving the chemical structure of the compound and of the metabolite of the compound,
(b) calculating values for one or more physicochemical parameters selected from the group consisting of heat of formation, heat of solvation, electrostatic potential, and band gap of the compound and of the metabolite of the compound based on one or more stored algorithms, and
(c) outputting the values for heat of formation, heat of solvation, electrostatic potential, and band gap of the compound and the metabolite.

2. The method of claim 1, wherein the method comprises calculating values for heat of formation, heat of solvation, electrostatic potential, and band gap of the compound and of the metabolite of the compound based on one or more stored algorithms.

3. A computer implemented method for predicting toxicity of a compound and of a metabolite of the compound, the method comprising:
(a) receiving the chemical structure of the compound and of the metabolite of the compound,
(b) calculating values for heat of formation, heat of solvation, electrostatic potential, and band gap of the compound and of the metabolite of the compound based on one or more stored algorithms, and
(c) outputting the values for heat of formation, heat of solvation, electrostatic potential, and band gap of the compound and the metabolite.

4. The method of claim 3, wherein the method comprises calculating values for one or more physicochemical parameters selected from the group consisting of heat of formation, heat of solvation, electrostatic potential, and band gap of the compound and of the metabolite of the compound based on one or more stored algorithms.

5. The method according to any one of claims 1, 2, 3, and 4, wherein outputting the values is to a user, a user interface device, a monitor, a printer, a data storage medium, a computer readable storage medium, or a local or remote computer system.

6. The method according to any one of claims 1, 2, 3, and 4, wherein outputting the values includes storing the values in a database or a library.

7. The method according to any one of claims 1, 2, 3, and 4, wherein outputting the values includes displaying the values of heat of formation, heat of solvation, electrostatic potential, and band gap of the compound and of the metabolite of the compound.

8. The method according to claim 1 or claim 2, the method further comprising testing the bioactivation of the parent compound and of the metabolite of the parent compound.

9. The method according to claim 3 or claim 4, the method further comprising testing the toxicity of the parent compound and of the metabolite of the parent compound.

10. A data processing system for use in predicting molecular bioactivation or toxicity of a compound and of a metabolite of the compound, the system comprising a processor and accessible memory, the system particularly configured to perform the acts of:
(a) receiving the chemical structure of the compound and of the metabolite of the compound,
(b) calculating values for heat of formation, heat of solvation, electrostatic potential, and band gap of the compound and of the metabolite of the compound based on one or more stored algorithms, and
(c) outputting the values for heat of formation, heat of solvation, electrostatic potential, and band gap of the compound and the metabolite.

11. A non-transitory computer readable storage medium comprising computer readable instructions for:
(a) calculating values for heat of formation, heat of solvation, electrostatic potential, and band gap of a compound and of a metabolite of the compound, and
(b) outputting the values to a user, a user interface device, a monitor, a printer, a computer readable storage medium, or a local or remote computer system.
